(19) United States
(12) Patent Application Publication
(10) Pub. No.: US 2002/0159215 A1
(43) Pub. Date: Oct. 31, 2002

(54) Protecting transmissive surfaces

(76) Inventor: Harold Edward Siess, Gaithersburg, MD (US)

Correspondence Address: Harold E. Siess, 8629 Welbeck Way, Gaithersburg, MD, 20879, US

(21) Appl. No.: 10/134,682

(22) Filed: Apr. 30, 2002

Related U.S. Application Data
(63) Continuation-in-part of application No. 09/455,164, filed on Dec. 6, 1999, now Pat. No. 6,379,427.

(51) Int. Cl. H01T 23/00; B03C 3/41

(52) U.S. Cl. 361/232; 96/97

(57) ABSTRACT

The present invention provides for an apparatus for protecting transmissive surfaces from infectious airborne agents. The apparatus comprises a means for providing and directing a sterile flow of charged breathable gas in the form of an electrohydrodynamic flow over a transmissive surface; and means for influencing the movement of said electrohydrodynamic flow for protecting said transmissive surface.

### BACKGROUND OF THE INVENTION

An aerosol is a colloidal suspension of liquid droplets or solid particles in a gas such as air. A bioaerosol is an unstable suspension of complex colloidal particles entrained in a gas that are comprised of or has attached thereto one or more microorganisms such as viruses, bacteria, fungi or protozoa. Bioaerosol particles can vary in size from a virus, 0.1 μm diameter or less, to a single bacterium, about 1 μm in diameter, to agglomerations of about 50 μm in diameter. Bioaerosols are commonly classified according to the means by which they are generated. Bioaerosols that are generated by human activities are classified as either extramural or intramural. (See Atmospheric Microbial Aerosols Theory and Applications Ed. by B. Lighthart and A. Mohr Chapman & Hall NY Londan 1994) Extramural bioaerosols are defined as those produced as sprays in liquid droplets from nozzles in agricultural applications, spray from manufacturing processes, bursting bubbles from wastewater treatment plants, or as dry particles from urban vehicular activity and rural agricultural practices.

Intramural bioaerosols are of a type that “may be generated during walking, sneezing, coughing, talking, shedding of skin flakes, surgical and dental processes, and household activities including ventilation with or without air conditioning, household cleaning, toilet flushing and so on.”

A surface on an object in contact with air containing bioaerosols can become contaminated. Contamination of surfaces that are part of the human body can lead to the direct transmission of disease. Diseases can also be transmitted by contaminated surfaces that come into contact with the human body. Both types of surfaces are hereafter referred to as transmissive surfaces.

Contamination of transmissive surfaces is a result of either simple diffusion processes and/or the projection of the bioaerosol particles onto the surface. At long ranges, bioaerosol particles can be projected onto surfaces by static forces such as the well known gravitational force and/or thermophoretic forces. For particles larger than about 50 μm in diameter and density of water, contamination of the surface is usually a result of sedimentation due to gravity. Thermophoreitc effects become large when there are either (1) large differences in the temperature of the particles (air) and a surface or (2) when the particles are exposed to radiant heating by such devices as lights.

In addition to gravitational and thermophoretic forces, in those cases wherein either the particle or the surface is charged additional static forces such as electrostatic or electrophoretic can also assist in the projection of bioaerosol particles onto surfaces from long ranges.

Bioaerosols can also be projected onto surfaces by non-static forces such as inertial forces imparted to the airborne agents by either a fluid flow, the mechanical movement of one or more objects or tools or by coughing sneezing and the like. In general, fluid flows of the type that project airborne agents onto surfaces can be characterized as either functional or incidental flows. Non-limiting examples of functional flows include unbounded streams of gases such as air that are used to create micro-environments. Non-limiting examples of incidental flows include turbulent flows created by the stirring or agitation of quiescent or moving air non-turbulent flows such as those created by natural convection.

Turbulent airflow near a surface is commonly divided into three regions: the turbulent core, the transition or buffer region, and the boundary layer next to the surface. In order to deposit on the surface, bioaerosol particles that are either created by or contained in turbulent airflows must be projected cross the boundary layer in the process of deposition. In the presence of turbulent flows particles are projected across the boundary layer by the momentum and density fluctuations of small subregions of the fluid which “downsweep” particles onto the surface. [see Kline et al., J. Fluid Mech., 30 741 1967 and Corino et al., J. Fluid Mech., 37 1 1969 and kim et al., J. Fluid Mech., 50 133 1971 and Grass A. J. Fluid Mech., 50 322 1971.] Classic high-speed photographs of colloid deposition from flowing turbulent fluids give support to this downsweep deposition mechanism. [see for example Corino et al., J. Fluid Mech., 37 (Part I): 1-30 1969 The major determining factor in the deposition of particles as a result of turbulent flow is therefore the number and magnitude of these “downsweep” flows. Pat Efforts for Protecting Transmissive Surfaces

Attempts to protect surfaces on objects such as the human body or surfaces contacted by the human body from airborne contaminants due to diffusion have centered on the use of air purifiers to remove macroscopic contaminants. For this purpose, air ventilation systems for buildings generally include an air filter and/or an electrostatic precipitator. However, it is well known in the air, that while the quantity of contaminants that reach the space to be protected can be reduced by such means it is not possible to completely preclude the entry of small airborne contaminants having a diameter less than 10 μm, such as bacteria, viruses and the like. In addition to incomplete filtering of air, such ventilation systems also create incidental flows of air that can project airborne agents onto transmissive surfaces.

In the filtering of air there is a build up of particles on the surface of the filter that reduces the efficiency of operation. In order to reduce this effect use has been made of re-circulation devices for circulating the air after use.

Electrostatic space charge air purifiers, such as those described in U.S. Pat. Nos. 6,126,722 3,696,791 4,390,923 4493289 and 4,388,667, have been another approach used for purifying the air. In this method of protection a cloud of charged particles is produced in and dispersed throughout an enclosed space for both electrifying and directing bio-aerosols onto a grounded surface. This method of air purification has disadvantages associated with it, chief among them are:

1. Transmissive surfaces that are not grounded have charged bioaerosols accumulate on them until the electrostatic charge thereon is equal to the air potential.

2. For transmissive surfaces that are grounded there is a continuous deposition of charged bio-aerosols thereon.

3. The electrostatic fields are not directed to manipulate charged bio-aerosol that are projected at the transmissive surfaces away therefrom but rather the electrostatic field is directed at least for a time at all surfaces under the influence of the space charge effect.

4. The concentration of charged particles within the throw range of a bio-aerosol generator does not provide for the charging of all the particles produced before deposition.

5. The grounded collection electrodes are not positioned for capturing the bio-aerosol particles before contacting a transmissive surface but rather may pass bio-aerosol particles generated in one region of the room over and onto transmissive surfaces as they are electrostatically directed onto the grounded electrode.

6. The electrostatic configuration of the ion generator and collecting electrode do not provide for the removal of bioaerosol clouds produced by mechanical bio-aerosol generators from an area or region where an operator need visual access i.e., needs to see through cloud of bio-aerosol particles produced by, for example, a bio-aerosol generator.

II Gas Curtains

In order to overcome the problems associated with the deposition of airborne agents onto transmissive surfaces due to both diffusion and incidental flows use has been made of gas curtains such as those described in U.S. Pat. Nos. 4,140,105 and 4,471,686. To this end it is known to install in an operating room a blower which directs a single stream of sterilized air above and across the platform of the operating table so that the stream of sterilized air prevents germs in the surrounding area from reaching the patient resting on the platform in the course of an operation or other type of treatment. Such mode of shielding the patient is quite satisfactory as long as the air stream is not interrupted, for example, by the hand(s) and/or arm(s) of the surgeon and/or his or her assistant(s). Once the air stream is interrupted, germs from the surrounding atmosphere can penetrate into the area above the platform of the operating table. Since the air stream is most likely to be interrupted in the region where the surgeon makes an incision or removes bandages from an unhealed wound, the aforedescribed equipment cannot prevent bacteria and/or other germs from reaching and eventually infecting the wound.

Other problems associated with the use of air curtains include but are not limited to:

1. Entrainment of airborne agents into the curtain by the production of incidental flows created by the flow of the curtain itself;

2. During the manipulation of a tool on or adjacent to a transmissive surface an air curtain creates powerful incidental flows that are capable of allowing airborne agents to penetrate the main flow and eventually alight upon the transmissive surface;

3. Such air curtains increase the convective and evaporative heat loss from the transmissive surfaces such as wounds and the like;

4. Such air curtains also increase the convective and evaporative moisture loss from surfaces having a high moisture content than the flow.

5. In the use of gas curtains it is difficult to protect more than one transmissive surface at a time.

6. Airborne agents produced during a manipulation of the transmissive surfaces is entrained into the main flow where it can be transmitted to other areas.

7. The flow and therefor the effective benefit of a air curtain can be easily blocked by the movement of objects or personal.

8. The presence of a low pressure region sucks in particles from the sea of gas surrounding at the ejection port the curtain and entrains them into the curtain.

III Vacuum Systems

Other methods used to overcome the problems associated with the deposition of airborne agents due to diffusion and incidental flows include the use of vacuum systems for removing airborne agents. Examples of such vacuum systems include U.S. Pat. Nos. 3,537,447 4,650,171 and 5,215,539. However, such vacuum systems are limited in the range of operation.

IV Physical Barriers

a. Shields

Another method used to overcome the problems associated with mechanically projected and flow projected airborne agents has been physical barriers. However conventional barriers often limit visibility and/or access to a transmissive surface. In addition, such barriers create incidental flows, in a fan like motion, when moved.

B. Garments

Other methods used to overcome the problems associated with the deposition of airborne agents due to mechanically projected and flow projected airborne agents have been garments. However, most garments, for example surgical garments, are not intended to, and do not prevent, the spread of harmful substances to all parts of the general operating room environment and do not protect certain parts of the wearer. For example, garments do not protect the eyes and other exposed parts of the body form contact with fluids in the form of airborne aerosols including bone particles and liquid from direct sprays, streams, or splashes of liquids. Garments that completely cover the body such as those that resemble astronaut's space suits protect only the person wearing it and provide no protection to others in the room against airborne agents. The production of such airborne agents in medical facilities can cause contaminants to come into contact with the mucus membranes of the medical staff. Airborne agents of this type can contain live viruses, including the AIDS virus, when such is present in the patient. Accidental contamination with airborne aerosols of blood and body fluids of patients having other diseases, such as hepatitis B, may also be communicated by such a mechanism.

C. Masks

d. The problem of no feedback mechanism

In addition to the many problems associated with the past efforts to stop the transmission of bio-aerosol particles onto humans, the methods and apparatuses used do not provide for sampling or detecting the presence or level of bio-aerosols produced or contained in the air. Thus there is no mechanism for feedback control of operation. What is needed in the art

1. A system of air purification wherein particle producing incidental flows are not created;

2. A protective quiescent boundary layer of gas such as air over the transmissive surface for protecting it from flow projected particles.

3. An electrostatic system that can protect transmissive surfaces from non-electrostatically manipulative particles contained in flows.

4. Allows for the protection of more than one transmissive surface.

5. A protection system that allows for the collection of the harmful airborne agents.

6. A protection system that does not spread the harmful airborne agents.

7. Allows for a method for determining the presence of harmful airborne agents.

8. A protection system that does not unduly remove or add heat or moisture to the transmissive surface.

9. Point of operation protection is needed without significant loss of mobility and/or visibility.

10. A collection and conveyance system for removing airborne debris generated during a medical procedure.

11. A method and apparatus for preventing the general dispersion into a room, or other enclosed space, of airborne contaminants such as aerosolized drugs and microorganisms that are emitted from a localized source within the room.

12. A method and apparatus for better protecting an individual or particular equipment at a localized region of a room from exposure to contaminants that exist in the ambient air of the room.

13. a method and apparatus for protecting a transmissive surface on an object from harmful airborne agents spread by either a functional or incidental flow of gas.

14. a method and apparatus for imparting a functional or incidental flow with a velocity component for directing uncharged and other non-electrostatically manipulative harmful airborne agents away from a transmissive surface.

15. a method and apparatus for protecting a transmissive surface on an object for harmful airborne agents spread by a convective heat flow which is produced by lighting of a surface.

16. a method and apparatus for confining harmful airborne agents to the smallest area possible and thus, minimize its dissemination and ultimate spread to other areas for preventing nosocomial or nosogeographic infections such as tuberculosis.

17. a method and apparatus for simultaneously shielding a patient and medical practitioner for pathogen carrying aerosols produced by a patient during a medical operation.

18. a method and apparatus for protecting a transmissive surface using an shock prove (air) electrode.

19. A method and apparatus for removing obstructive aerosol particles from operational view.

### SUMMARY OF THE INVENTION

As used herein the words “vision field” is defined as the region of space as seen by an object if it had eyes all about it.

As used herein the words “sea of harmful airborne agents” is defined as a volume of air containing harmful airborne agents that, like a sea of water, may or may not contain one or more flows but does not consist of a flow. In the sea, the harmful airborne agents are substantially evenly dispersed and their movement is substantially diffusive in nature.

As used herein the word ‘deposition’ refers to the mean probability of an inspired particle being deposited in the respiratory tract by collection on airway surfaces.

As used herein the words ‘total deposition’ refers to particle collection in the whole respiratory tract. As used herein the words ‘regional deposition’ refers to the particle collection in a region of the respiratory tract.

As used herein the words “infective surfaces” is defined as surfaces which are subjected to infectious agents such that they become capable of causing or communicating infection.

As used herein the words “electrohydrodynamics” is defined as the coupling of an electric field and a velocity field in a fluid continuum.

As used herein the word “wound” is intended to include: surgical incisions, abrasions, cuts, punctures, blemishes, tears, sores, blisters, burns, contusions, tissue ruptures or other types of areas of the body that have a reduced ability to protect the human body by reason of some type of physical impairment.

As used herein the words “exposed surfaces” are surfaces that are either part of the human body or are surfaces that come into intimate contact with the human body during normal use and as such can transmit, pass or otherwise act as a source for toxic, harmful or infectious airborne agents to humans.

As used herein the word “medical contact surface” are defined as surfaces normally contacted by a medical staff member during a medical procedure including the surfaces of tools, support equipment and the like.

The present invention relates to the protecting of exposed surfaces that can transmit, pass or other act as a source of toxic or infectious airborne agents to humans such that humans become infected or contaminated by the airborne substance. In particular, this invention relates to the protecting of exposed surfaces from toxic and/or infectious airborne agents where the protecting of such surfaces for health and safety reasons is desirable. More particularly, the present invention relates to the protecting of exposed animate surfaces such a human or part thereof such as, but not limited to, skin, lungs, eyes, mucus membranes and wounds thereon.

The present invention is useful for protecting the exposed surfaces of patients and medical staff from noxious airborne agents. In particular, the present invention is useful for the protecting of patients with reduced immune responses from such conditions as AIDS or have an increased risk of infection due to such conditions as illness, wounds or surgical wounds. In addition, the present invention is useful for protecting exposed inanimate surfaces, such as polymeric materials, glass, rubber, metal, food and drugs, that come into intimate contact with humans such that they can transmit, pass or otherwise act as a source of toxic or infectious airborne agents to humans. In particular, the present invention is useful for protecting inanimate surfaces such as, but not limited to, medical equipment, food, food handling equipment, drugs and drug handling equipment.

The present invention relates to the protecting of exposed surfaces from noxious airborne agents such as, but not limited to, (1) industrial particulates, (2) infectious matter such as bacteria, viruses, fungal spores, and aerosols that may carry these infectious agents, (3) potential disease-carrying aerosols produced from blood and other bodily fluids, small particles of skin, fat, muscle tissue and bone, (4) particles which may be emitted form a human body such as respiratory droplets, skin squamae, and hair, (5) allergenic materials such as pollen, spores, and animal dander, (6) caustic agents such as airborne acids and bases and (7) aerosols used as chemical or biological warfare agents. More particularly, the present invention relates to methods and apparatuses for protecting exposed surfaces from harmful airborne agents produced unintentionally by or during human activity. In particular, the present invention is useful for protecting exposed surfaces from harmful airborne agents produced by or during the following activities: (1) the operation or medical tools such as high speed drills, saws, reamers, and cutting equipment and other tissue removing implements; (2) the release of contaminants from various medical procedures such as the insertion or withdrawal of tubes and other medical procedures wherein an instrument is brought into physical contact with bodily fluids; (3) the release of contaminants as by suctioning or by irrigation; and (4) the release of emitted particles such as respiratory droplets and skin squamae from infected patients during breathing or movement of the body.

The present invention is applicable to the protecting of exposed surfaces from airborne agents in both open areas and in reduced spaces as found in enclosures. In particular, the present invention is applicable to the protecting of exposed surfaces from airborne agents in buildings such as hospitals, medical and dental consultation rooms, laboratories, drug manufacturing plants, food production facilities and the like. In addition, the present invention is applicable to the protecting of exposed surfaces from airborne agents in reduced spaces as found in vehicles. In particular, the present invention is applicable to the protecting of exposed surfaces form airborne agents in vehicles such as ground craft, aircraft, spacecraft, marine craft and the like.

The present invention provides for a method and apparatus for protecting transmissive surfaces such as human flesh and infective surfaces from harmful agents suspended in, transported by or otherwise spread by a gas such as but not limited to air, comprising the steps of: enlarging and electrifying harmful airborne agents and placing an electrostatic charge within a functional distance from an exposed surface for the protection of the same.

The present invention also provides for methods and apparatuses for protecting transmissive surfaces from harmful agents that are either deposited upon transmissive surfaces by diffusional processes or transported by one or more types of depositional flows. In particular, the present invention provides for methods and apparatuses for the protection of transmissive surfaces from harmful airborne agents created or transported by either (1) depositional flows caused by agitation, stirring or turbulence of a gas, or (2) functional flows such as, but not limited to, filtered or otherwise purified air flows meant for general human use being generally referred to as ventilation air and functional flows of air in the form of isolated flows of gases that are used to create a controlled micro-environment and are hereafter referred to as gas curtains isolation flow.

The method for the protection of exposed surfaces from infectious airborne agents contained in a depositional flow comprises the steps of first providing a plurality of charged particles in at least a portion of an unbounded incidental functional flow, such as, but not limited to, a purified or sterilized flow for forming charged harmful airborne agents in the flow. Electrostatically manipulating the charged harmful airborne agents contained in the flow for forming a substantially harmful free flow zone or area in at least a portion of the flow and then passing the particle free zone over an exposed surfaces for protecting the surface form particles.

In the method of operation of the present invention for the protection of the surfaces on or attached to inanimate objects a transmissive surface is first provided in a clean or sterilized and/or biocidal condition and electrostatically checked or monitored for surface impurities in accordance with the teachings of the present invention. In one form of the present invention for the electrostatically monitoring the surface for impurities the surface is sterilized chemically or with electrifying particles such as ions, electrons or photons for forming a sterilized surface in an electrified state. The electrostatic state of the surface is then checked or monitored for determining the presence of impurities. In another form of the invention, the surface is first sterilized and then charged or (2) the surface is electrified otherwise electrified by providing the surface with as an electrostatically charged surface upon sterilization.

In one particular form of the present invention, a sterilized and biocidally conditioned transmissive surface is provided by first impregnating the surface, which may be of a synthetic or nature polymer with a pre-biocidal material such as for example a terpene compound for forming a transmissive surface having a continuous supply of pre-biocidal agent thereto. The impregnated surface is then activated for both (1) sterilizing the surface and for (2) forming a biocidal protective layer thereon. In those cases wherein the impregnated species is a terpene compound, an oxidizing environment can be provided by the use of an oxidizing agent with or without UV light, plasma discharge or some other oxidizing enhancer activating the pre-biocidal agent and thereby forming a biocidal layer thereon and for electrostatically charging the surface. The charge on the surface is then checked or monitored for determining the level of sterilization and/or the presence of impurities.

After an essentially sterilized transmissive surface has been provided it is placed in an environment laden with infectious airborne agents for use therein.

A plurality of infectious airborne agents are electrostatically charged and increased in size for subsequent electrostatic manipulation away from transmissive surfaces.

The method for the simultaneous enlargement and charging of particles comprises the steps of forming a flow of a material that is substantially dielectric and frictionally charging the material. The charged material is then formed into a charged cloud that is contacted with airborne particles for electrifying the particles for subsequent manipulation. In one form of the invention, the material is in the form of carbon dioxide for forming a cold cloud of ionizing vapor that both charging and enlarges the particles by the condensation of moisture already present in the ambient air. In another form of the invention, the particles are enlarged in a gas-to-particle reaction.

After the infectious airborne agents have been electrified one or more electrodes are actuated for electrostatically manipulating infectious airborne agents away from the transmissive surfaces. The type of electrodes and the electrode configuration used for protecting a transmissive surface is chosen according to whether the infectious airborne agents are deposited by diffusional processes, turbulent or functional flows or by inertial projection. In those cases wherein the infectious airborne agents are deposited by either turbulent or diffusional processes it is preferred that the transmissive surface be charged for acting as a repellant electrode. For this purpose the transmissive surface can be provided with an electret layer for forming a permanently charged and non-hazardous electrode. In this form of the invention, a biocidal layer may also be provided on the surface.

In functional flows containing infectious airborne agents such as laminar flows in the form of gas curtains used for providing for a controlled micro-environment such as a therapeutic environment, the electrostatic manipulation of the infectious airborne agents is controlled by first creating a laminar flow of a gas in the form of an isolation flow for forming a micro-environment adjacent to one or more exposed surfaces. The flow is then electrostatically charged for forming a charged laminar flow and for charging the infectious airborne agents therein. Electrodes are then actuated for forming a stratified flow comprising a substantially harmful airborne agent free flow zone or area in at least a portion of the flow for protecting the surface from harmful airborne agents.

In one form of the present invention, a functional flow comprising an ultra-pure or sterilized flow is formed for providing an ultra-pure or sterile micro-environment for use in a medical procedure. Charged particles are then introduced into the main flow or sub-flow regions and electrostatically manipulated for further purifying the flow or for maintaining the purity of the flow.

In the method for further purifying the gas, charged particles are injected into the main flow for combining with or otherwise electrifying harmful airborne agents contained therein. The flow is then passed through an electrostatic or magnetic field having a vectoring component transverse to the direction of flow for separating or stratifying the flow into zones comprised of differing concentrations of harmful airborne agents. The least contaminated flow is then utilized for creating an improved micro-environment.

In the method for maintaining the purity of the flow, a flow or stream of gas is formed in a conduit for transporting gaseous matter. The flow of gas is then passed out an outlet for forming a flow of gas that is at least partially unbounded in a sea of contaminated gas. A charged particle source is than actuated for forming a cloud of charged particles in the induction region next to the unbounded portion of the flow for electrifying the contaminates that are drawn into that region. The electrified contaminates are then electrostatically manipulated away from the flow for reducing the contaminate particle concentration in the flow.

The present invention also provides for a method and apparatus for recycling air in an enclosure containing an exposed surface for increasing the performance or life of an air purifier such as for example a filter medium. The method comprises the steps of first forming a flow of filtered air. The flow of filtered air is then passed over one or more surfaces for maintaining a low level of airborne agents thereon and thereby forming a used flow of air containing harmful airborne agents. The harmful airborne agents are then charged for forming charged harmful airborne agents. The charged harmful airborne agents are then separated from the used flow of air for forming an electrostatically clean flow of air. The flow of electrostatically clean air is then passed through a filter for recycling the air.

The present invention provides for a method and apparatus for protecting both animate and inanimate objects, from harmful airborne agents. The method comprises the steps of first, connecting a charging device to an object, for providing a positive charge thereto. One or more radiation sources are also actuated for forming one or more beams of radiation, which can be UV radiation, for impinging upon a plurality of harmful airborne agents for ejecting an electron therefrom and thereby electrifying the harmful airborne agents with a positive charge for repelling the harmful airborne agents from the positively charged object for protecting the object from harmful airborne agents.

While not limited thereto in its utility, this invention is particularly well suited for use in a medical procedure and thus will be described in such an environment. The present invention provides for a method and apparatus for protecting disease transmitting surfaces during a medical procedure undertaken in a medical environment. The method comprises the steps of first sterilizing a transmissive surface for removing infectious agents for forming a sterilized surface. Providing the sterilized surface in a medical environment for use in a medical procedure. A plurality of charged airborne particles are then provided in the medical environment for electrifying infectious airborne agents therein for forming charged infectious airborne agents. The charged infectious airborne agents are then electrostatically manipulated for protecting the disease transmitting surfaces. In one form of the present invention the charged particles are electrostatically manipulated for forming a substantially infectious airborne agents free micro-environment in said medical environment comprised of a sea of un-charged particles for protecting the disease transmitting surfaces.

The present invention provides for a method for reducing the deposition of airborne anthrax into the lungs of a postal worker. The method comprising the steps of first transporting a letter from one location to another by use of a transporter thereby generating an aerosol comprising anthrax. The transporter can be either a mechanical device or in the form of a postal worker. During the transportation of the letter a charged particle source is actuated for forming a cloud of charged particles that passes over the moving letter for charging the anthrax particles. For this purpose the charged particle source can be directly attached to the transporter. The charged airborne anthrax particles are electrostatically precipitated onto the nasal cavities and upper respiratory track of a postal worker for protecting the lungs of postal worker.

Slaughter House.

The present invention provides for a method and apparatus for protecting an object from harmful airborne agents using ionizing radiation. In the first step of operation of the radiation charger, a radiation source is actuated for forming a beam of ionizing radiation which is focused upon a plurality of harmful airborne agents for ionizing them by the photoelectric effect for forming a plurality of charged harmful airborne agents. The radiation source can be a flashlamp or an excimer laser, a doubled or quadrupled YAG laser or a source of x-rays such as soft x-rays. Other sources of radiation include mercury lamps, hyddrogen discharge tubes, xenon discharge tubes and Lyman discharge tubes. Moreover, sterilizing lamps, chemical lamps, black lamps, and fluorescent chemical lamps may be used. The beam can be focused by use of MgF2 windows. The in next step an object to be protected is isolated from ground by use of for example an insulative mat and charged for electrostatically manipulating the charged harmful airborne agents away therefrom. The charging device can be an electret, electrostatic generator, an inducer for placing an electrostatic charge on exposed surface by induction, or a charged particle emitter for placing an electrostatic charge on the object by charged emission therefrom. An electrostatic charge indicator can be placed operationally in contact with the object for indicating the charge thereon.

The present invention provides for several different configurations for ionizing the harmful airborne agents in accordance with their relative position to the object to be protected. In particular, the beams can be focused:

a) within the vision field of the exposed surface for ionizing harmful airborne agents having a vector component that is directed at the object to be protected;

b) can be focused in a sea of harmful airborne agents for ionizing harmful airborne agents that would otherwise deposit onto the object by diffusive processes;

c) can be focused within the electrostatic field generated by at least a portion of the object for directing away harmful airborne agents contained therein;

d) can be focused within the travel path of the object for ionizing and repelling harmful airborne agents that would otherwise come into contact with the object as it traveled along.

The present invention provides for a method and apparatus for protecting transmissive surfaces from harmful airborne agents projected across the boundary layer by turbulent action or the projection of bio-aerosols by a repulsive electrostatic charge an the exposed surface. The apparatus comprises a direct able ion source for directing a cloud of ionized minute particles over a transmissive surface. In one form of the invention, the direct able ion source is comprised of a goose neck coil for directing the charged cloud manually. One or more aiming lights can be positioned onto the ion source for aiming the cloud over the surface. The charged functions to:

1) placing a charge of single polarity on agents 130,

2) maintaining the charge of a single polarity on agents 130

3) neutralizing unwanted charges that may be present and

4) charging particles that may or may not be infectious in nature that are contained in either functional or incidental flows for forming charged flows that can be electrostatically manipulated for indirectly electrostatically manipulating the charged and uncharged particles therein.

The transmissive surface is given a repulsive charge for:

1) restraining projected infectious airborne agents away from the transmissive surface that would due to their momentum otherwise come into contact with the transmissive surface by use of a repellant force,

2) directing charged functional or incidental flow away from the surface for protecting the surface from both charged and neutral infectious matter contained int the flow by reducing the number and/or magnitude of a plurality of downsweep flows reaching the surface;

3) for forming an electrostatically enhanced non-depositional quiescent or stagnant layer adjacent to surface for protecting the transmissive surface from both neutral and charged agents created or carried agent to surface by turbulent flows and;

4) for forming an electric flux capable of directing either (a) charged infectious airborne agents or (b) charged flows away from the surface to a preselected area generally such as an evacuation or disposal site.

An electrostatic charge sensor can be positioned on or within the electrostatic field emitted by the transmissive surface for monitoring the repulsive charge thereon. An air charge sensor can also be positioned for:

a) monitoring the protecting charged cloud above surfaces 124 and 126 for assuring adequate charging of infectious airborne agent and flows;

b) monitoring the exposure level of patients or medical staff to aerosols;

c) monitoring the degree of evacuation of the charged infectious airborne agent out of the area and;

d) for providing feed back control to the charged particle source and/or one or more focusing or collection electrodes for either focusing or collecting the charged cloud within an area containing bio-aerosols or within an area of bio-aerosol formation.

An air flow induction device such as an evacuator can be provided for capturing either the charged infectious airborne agents or charged flows in an induced flow for removal from the area. The infectious airborne agent that are removed from the area can be:

a) collected on a collection electrode

b) filtered

c) treated by known methods such as UV radiation or chemical treatments

d) or evacuated to the outside of the room.

A current detector can be operatively connected to the evacuation for measuring the current therethrough for providing feedback control to the air flow induction device and/or the charged particle source. In addition to monitoring the level of performance of the overall system, the use of the current detector allows for the monitoring of the sudden appearance of aerosol particles by noting deviations in the current over short time periods caused by differences in charged particle mobility. An indicator can be connected to the current detector for giving an indication of the level of airborne agent pickup for giving an indication of the level of performance or the formation of aerosol particles.

### BRIEF DESCRIPTION OF THE DRAWINGS

FIG. 1, shows a schematic of a method and apparatus for protecting an object from harmful airborne agents by the use of a radiation charger.

FIG. 2, shows a schematic of a method and apparatus for protecting transmissive surfaces in the form or the human body or parts thereof from agents suspended in, transported by, or otherwise spread by air by the use of an electrostatic charge on a transmissive surface.

FIG. 3, shows a method and apparatus for forming a cloud of electrifying particles within at least a portion of a projection radius of a source of bioaerosols for electrifying harmful airborne agents therein.

FIG. 4, shows a method and apparatus for forming a cloud of electrifying particles within an area where a medical procedure takes place for electrifying harmful airborne agents therein.

FIG. 5, shows a method and apparatus for forming a cloud of electrifying particles within the vision field of a transmissive surface for electrifying harmful airborne agents therein.

FIG. 6, shows a method and apparatus for protecting transmissive surface on inanimate objects from infectious airborne agents

FIG. 7 shows a method and apparatus for protecting a transmissive surface by the use of a repulsive air electrode.

FIG. 8 shows a method and apparatus for protecting a transmissive surface by the use of an “hard” electrode.

FIG. 9, shows a method and apparatus for protecting a transmissive surface by a attractive electrostatic field.

FIG. 10, shows a schematic of a method and apparatus for protecting a transmissive surface by an attractive electrostatic field generated by one or more “hard electrodes”.

FIG. 11, shows a method and apparatus for protecting an individual from inhalation anthrax.

FIG. 12, shows a method and apparatus for reducing the deposition of airborne anthrax onto the lungs of a postal worker.

FIG. 13, shows a schematic of a method and apparatus for protecting an exposed surface from harmful airborne agents contained in convective flows created the illumination of the surface.

FIG. 14, shows directing electrodes 1310 useful in accordance with the teachings of the present invention.

FIG. 15, shows a schematic of a method and apparatus for transforming airborne agents into charged electrostatically manipulative particles and the removal of the same from air.

FIG. 16, shows a cryogenic ionizer for forming a plurality of charged particles from finely divided carbon dioxide snow.

FIG. 17, shows a schematic of a self-cleaning electrode generally indicated by the numeral 1610.

FIG. 18, shows a schematic of steam ionizer for both electrifying and enlarging infectious airborne agents for their subsequent electrostatic manipulation.

FIG. 19A, shows a schematic of a method and apparatus for increasing the performance of a radiation source during therapeutic procedures.

FIG. 19B, shows a schematic of a corona electrode useful for creating a charged cloud in accordance with the teachings of the present invention.

FIG. 19C, shows a schematic of a method and apparatus for cooling a surgical site by use of a protected corona electrode having a protective gas layer there next to.

FIG. 20A, shows an apparatus for protecting one or more exposed surfaces during a medical utilizing a stratified isolation flow.

FIG. 20B shows a removable and/or disposable corona element in the form of an elongate bar for use in charging an isolation flow.

FIG. 20C shows an external electrode for an isolation flow in the form of a drape for creating a stratified flow.

FIG. 21 shows a schematic of a method useful in the operation of a vertical electrostatically enhanced air curtain in conjunction with a deflecting electrode for protecting one or more surfaces during a medical procedure.

FIG. 22A shows a schematic of a method and apparatus for protecting an exposed surface from harmful airborne agents by a completely stratified isolation flow.

FIG. 22B shows a schematic of a method and apparatus for protecting an exposed surface by a deflector for deflecting both charged and uncharged harmful airborne agents contained in a flow.

FIG. 23 shows a method and apparatus for forming an induction protected full air curtain.

FIG. 24, shows a method and apparatus for protecting an exposed surface by using recycled clean air.

FIG. 25A shows a harmful airborne agent collection device in the form of a vacuum device conformable to a surface of the human body.

FIG. 25B shows a charging member in the form of a voltage driven electrode.

FIG. 26 shows a schematic of an electrostatically enhanced isolation booth.

FIG. 27 shows a schematic of an electrostatically enhanced protective garment.

FIG. 28 shows a schematic of an electrostatically enhanced mask.

FIG. 29 shows a schematic of a method and apparatus for filtering air by use of an electrostatic mask.

### DETAILED DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Now referring to FIG. 1, there is shown a schematic of a method and apparatus for protecting an object from harmful airborne agents by the use of a radiation charger. The apparatus is a harmful airborne agent deflector generally indicated by the numeral 10.

The harmful airborne agent deflector 10 operates as now described. First, a charging device 12 is provided for establishing a positive electrostatic charge on at least a portion of an object 14. Charging device 12 can be comprised of, for example one of the following:

(1) an electret 16 that is bonded to object 14 by an adhesive material 15;

(2) an electrostatic generator 18 that is electrically connected to object 14 through an electrical cable 20;

(3) an inducer 30 for electrostatically charging object 14 by induction; or

(4) a charged particle source 32 for charging object 14 by the emission of a plurality of unipolar charged particles (not shown).

Charged particle source 32 can be comprised of a corona electrode 33, an electrostatic generator 35, a power source 37 for powering electrostatic generator 35 and an electrical cable 39 connecting electrostatic generator 35 to object 14.

An indicator device, such as a light or buzzer 41, of a type as described in U.S. Pat. No., 5,179,266 or the like can be connected to electrode 33 for indicating the operational level of electrode 33.

Object 14 can be isolated from ground in any known manner, such as an insulative mat 43, for maintaining an electrostatic charge on object 14.

After an electrostatic charge has been placed on object 14, one or more radiation sources 40 are actuated for forming one or more beams of radiation generally indicated by the arrow 42. Radiation source 40 may have a wavelength greater than 3 eV for ejecting electrons from harmful airborne agents 46 having an effective work function of greater than 3 eV. In one form of the invention, radiation source 40 has a wavelength greater than 6 eV for ejecting electrons from harmful airborne agents 46 comprised of water. Radiation source 40 can be, but is not limited to, an ultraviolet flashlamp or an excimer laser, a doubled or quadrupled YAG laser or a source of x-rays. Radiation source 40 can further comprise one or more lens 17 for focusing beams 42. Lens 17 can be comprised of, for example, quartz, LiF or MgF2 or other UV transparent material.

In one form of the invention, beam(s) 42 are focused within at least a portion of a vision field generally indicated by the arrows 44 for ejecting electrons from a plurality of harmful airborne agents generally indicated by the numeral 46 located therein for electrostatically charging at least a portion of agents 46 with a positive electrostatic charge for electrostatically manipulating agents 46 away form object 14 by a repellent charge.

In another form of the invention, beam(s) 42 are focused within a sea generally indicated by the arrow 47 of harmful airborne agents generally indicated by the numeral 48 that is in fluid communication with object 14 for electrifying agents 46 therein.

In still another form of the invention, beam(s) 42 are focused within an electrostatic field generally indicated by the arrows 50 for electrifying harmful airborne agents 48 therein.

In still yet another form of the invention, beam(s) 42 are focused within a travel path generally indicated by the arrow 52 such as a flight path or road for electrifying harmful airborne agents 48 therein. In this form of the invention, both radiation source 40 and lens 17 can be directly attached to object 14 for continuously illuminating the travel path 52. This form of the invention, can be used for, as a non-limiting example, is particularly useful for protecting occupants of a vehicle from harmful airborne agents in the form of a cloud of chemical or biological.

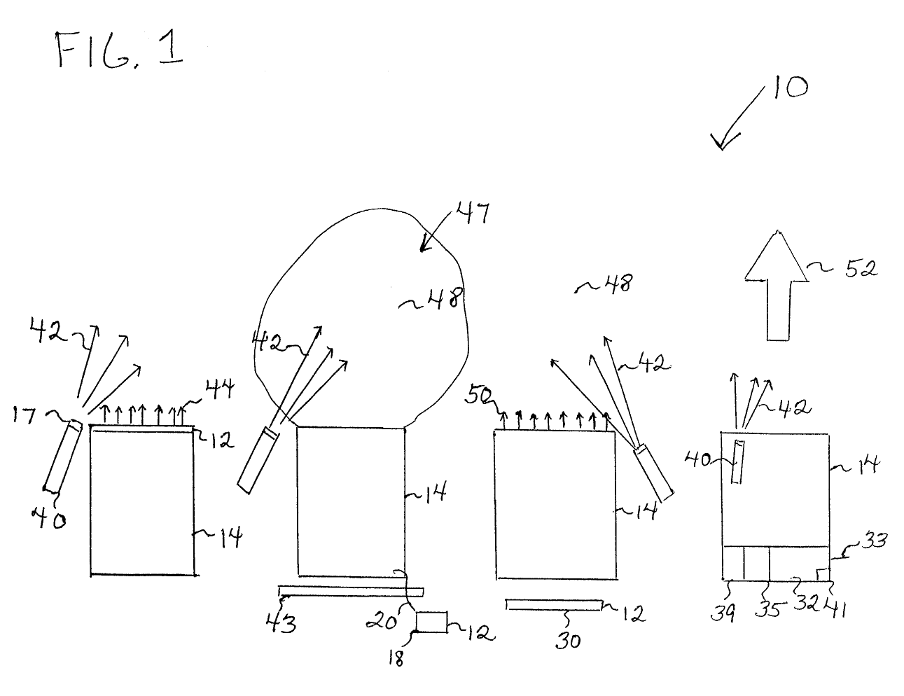

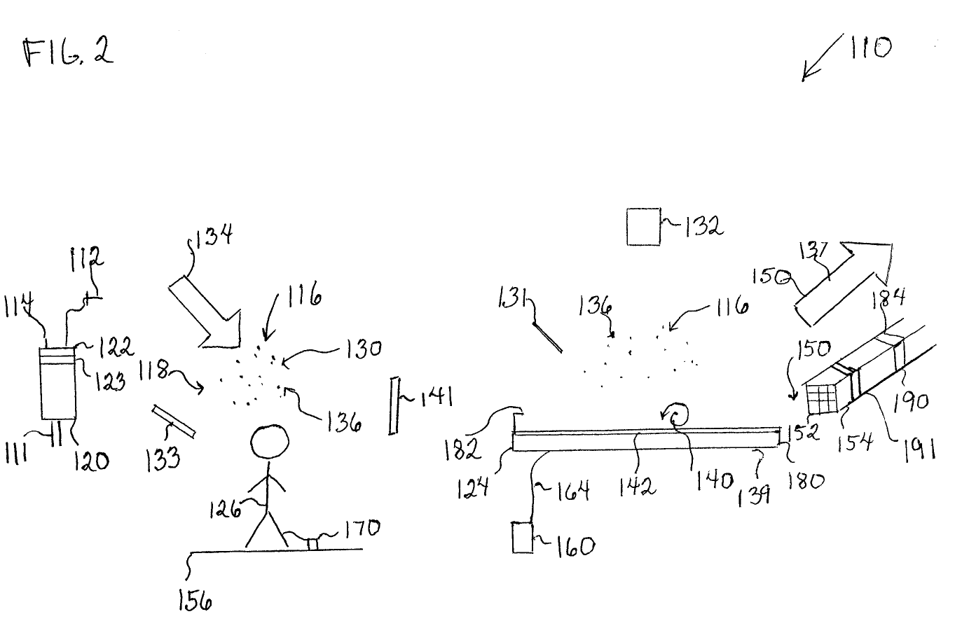

Now referring to FIG. 2, there is shown a schematic of a method and apparatus for protecting transmissive surfaces in the form or the human body or parts thereof from projected agents by the use of a repulsive electrostatic charge on the transmissive surface. The method is useful for protecting exposed surfaces from harmful agents suspended in, transported by or otherwise spread by a disseminating flow of contaminated air such as, but not limited to, functional flows in the form of a sterile flow of air that has been contaminated, ventilation or filtered or otherwise purified air meant for human use, or incidental flows such as, but not limited to, convective or turbulent flows. The method is also useful in protecting exposed surfaces from projected harmful airborne agents created by for example the operation or movement of a person or tool. The apparatus is an airborne agents arrester generally indicated by the numeral 110. Arrester 110 is useful for shielding transmissive surfaces that are amenable to electrostatic charging. In particular, arrester 110 is useful for shielding transmissive surfaces that amenable to electrostatic charging by, for example, and in no way limiting the present invention to, (1) conduction, such as metals, semiconductors and humans or parts thereof, (2) induction, and (3) objects capable of being charged by a space cloud such as dielectric material and insulated conductors form harmful airborne agents.

The airborne agents arrester 110 operates as follows. One or more adjustably positional charged particle source(s) 112 is positioned by a positional member 111, such as a goose neck coil of a type well known in the art, and actuated by use of an on/off switch 114 for producing and directing an expanding space charged particle cloud generally indicated by the numeral 116 comprised of a plurality of unipolar charged particles generally indicated by the numeral 118 over one or more transmissive surfaces 124 and 126.

Charged particle source 112 can be an art type of ionizer for forming a plurality of ions or electrons that form ions upon attachment to molecules or a charged particle source in accordance with the teachings of the present invention. For example, source 112 can be a corona device. Corona device 112 can be powered by a high voltage source 120. A high voltage rheostat 122 can be provided on power supply 123 for regulating the voltage through a range of 5 to 20 kV for varying the ion output from device 112. Source 112 may have an indication light, such as for example, as described in U.S. Pat. No. 5,157,9266 for indicating the operational status of source 112.

In one form of the invention, charged particle source 112 is of a type for releasing and directing charged particles 118 over transmissive surfaces 124 and 126 that are subjected to a plurality of infectious airborne agents generally indicated by the numeral 130 for forming an expanding protective ionic cloud layer 116 that can be relatively stationary or moving and that surrounds surfaces 124 and 126.

Agents 130 can be of a type that are projected by aerosol generating source 132 or agents 130 can be of a type that are projected by the momentum transfer of a functional or incidental flow generally indicated by the arrow 134. Infectious airborne agents 130 may also be of a type that are projected by the movement of an object 131 by manual manipulation or projected by the movement of one or more components of an electrically or pneumatically powered instrument 133. Infectious airborne agents 130 can be molecular, aerosol or droplet in nature. In particular, infectious airborne agents 130 can be: (1) projected particles from patients, such as but not limited to, (a) respiratory droplets expelled from the mouth during coughing, sneezing, or speaking, (b) skin squamae from infected patients during breathing or movement of the body; (2) nosocomial infectious matter projected by ventilation air sources including bacteria, viruses, fungal spores, and aerosols that may carry these infectious agents; (3) projected particles of blood and other bodily fluids, small particles of skin, fat, muscle tissue and bone, saliva, dental material and the like produced during a medical procedure; and (4) aerosols used as chemical or biological warfare agents.

In one form of the invention, transmissive surface 126 is comprised of the human body or parts thereof. In particular, surface 126 can be the eyes, skin, open wounds and other surfaces that can be electrostatically charged. More particularly, surface 126 can be a patient and/or medical staff member or an operator of a military vehicle. For transmissive surfaces 126 in the form of animate objects device 112 can be either (1) of a type well known in the art for producing low levels of ozone such as, but not limited to, those described in U.S. Pat. Nos. 4,672,504 and 4,366,525 the references contained therein, a low ozone producing device 112 in accordance with the teachings of the present invention or (2) a gaseous substance such as those in accordance with the teachings of the present invention can be released from a source for reacting with the ozone for forming a substantially less hazardous material.

After or during the creation of cloud 116 and its subsequent dispersion, charged particles 118 combine with, transfer their charge to or otherwise electrify infectious airborne agents 130, for forming a plurality of charged infectious airborne agents generally indicated by the numeral 136 and: (1) placing a charge of single polarity on agents 130, (2) maintaining the charge of a single polarity on agents 130 (3) neutralizing unwanted charges that may be present and (4) charging particles that may or may not be infectious in nature that are contained in either functional or incidental flows for forming charged flows that can be electrostatically manipulated for indirectly electrostatically manipulating the charged and uncharged particles therein.

One or more aiming lights can be positioned on charged particle source 112 for creating an illuminated region corresponding substantially to the ionic cloud layer for aiming charged cloud 116 over transmissive surface 126. An aerosol generating device, common aerosol can be positioned for forming a sterile and preferably flourescent aerosol spray within the illuminated region for detailing the region of cloud coverage when illuminated with exciting radiation.

The expanding ionic cloud 116 serves to both ionize and repel harmful airborne agents away from transmissive surfaces 124 and 126. In the preferred form of the invention, the repulsion effect is enhanced by placing an electrostatic charge on transmissive surface 124 and 126 for protecting surfaces 124 and 126 by one or more of the following actions: (1) restraining projected agents 136 away from surfaces 124 and 126 that would due to their momentum otherwise come into contact with surfaces 124 and 126 by use of a repellant force, (2) directing charged functional or incidental flow 134 away from the surface for protecting the surface from both charged and neutral infectious matter by reducing the number and/or magnitude of a plurality of downsweep flows 140 reaching surface 124; (3) for forming a non-depositional quiescent or stagnant layer 142 adjacent to surface 124 for protecting surface 124 from both neutral and charged agents created or carried agent to surface 124 by turbulent flows and; (4) for forming an electric flux capable of directing either (a) charged infectious airborne agents 136 or (b) charged flows away from surface 124 to and to a preselected area generally indicated by the numeral 150. Preselected area 150 can be comprised of, but is not limited to, (1) a mouth portion 152 of an evacuation means 154 for removing infectious airborne agents out of the sea of infectious airborne agents; (2) area 150 can be a collection electrode 156 for collecting charged infectious airborne agents 136 or area 150 can be a region of space wherein an extractive flow generally indicated by the arrow 137 for extracting charged agents 136 away from one or more exposed surfaces 139 that may be in the form of transmissive surface 124. Flow 137 can be an evacuation induced flow or a flow produced by a blower (not shown). In one form of the invention, collection electrode 156 is comprised of a section of flooring for collecting both charged and un-charged infectious airborne agents by electrostatic and gravitational forces.

Charged particle source 112, evacuation means 154 and or electrode 156 can be mounted on one or more surgical arms (not shown) for positioning these components where needed.

The electrostatic charge can be established on surface 124 and 126 by for example, induction, tribo-electrification, discharge treatment, electret application or by charged spraying techniques. The charge placed on surface(s) 124 is above ground and is preferably at least 2,000 volts. The charge can be either pulsed or constant. Whether a constant or pulsating electrostatic field is employed, the charge should not be great enough to generate charged particles, that is to say not so great as to become a discharge device.

In those cases wherein the surfaces 124 and 126 have a sufficient level of conductivity, the electrical charge can be established by operatively connecting one pole 160 of an electrostatic generator 162 to surface 124 through a cable 164. Examples of surfaces 124 having a sufficient level of conductivity include but are not limited to metals, semiconductor materials, flesh or wetted objects. Surfaces 124 that are not sufficiently conductive in nature may be made so by methods and solutions well known in the art and described in for example U.S. Pat. No. 2,372,829 entitled “Electrical Conducting Compositions for Paper and the Like in the Dry State”. In those cases wherein surface 124 is a human body or a part thereof an electrostatic generator 170 of the type described in U.S. Pat. Nos. 5,906,638 and 4,802,470 and references contained therein can be used. In those cases wherein surface 126 is in the form of a wound, ulcer or burn on a human body the electrode (not shown used can be of a type described in U.S. pat. No. 5,218,973 and references contained therein. It should be appreciated by those of ordinary skill in the art that in order to maintain the electrostatic charge on surfaces 124 and 126 it is necessary to properly insulate them from ground.

An additional electrostatic charge can be placed on one or more focusing electrodes 141 that are placed in functional contact with cloud 116 for enhancing the electrostatic protection of transmissive surfaces 124 and 126.

An electrostatic charge sensor 180, of a type well known in the art, can be connected to surfaces 124 and 126 for monitoring the charge thereon. In another form of the invention, electrostatic charge sensor 180 is in the form of a field meter of a type well known in the art is used for determining the charge on transmissive surfaces 124 and 126 at an operative distance. In this form of the invention, charge sensor 180 can be placed on surgical arms xx.

One or more air charge sensors 182 can also be positioned for:

a) monitoring the protecting charged cloud above surfaces 124 and 126 for assuring adequate charging of infectious airborne agent and flows;

b) monitoring the exposure level of patients or medical staff to aerosols;

c) monitoring the degree of evacuation of the charged infectious airborne agent out of the area and;

d) for providing feed back control to one or more focusing or collection electrodes for either focusing or collecting the charged cloud within an area containing bio-aerosols or within an area of bio-aerosol formation.

In addition a current detector 184, of a type well known in the art can be operatively connected to evacuation device 154 or electrode 156 for measuring the current therethrough for providing feed back control to the electrostatic charging and focusing means, through an electrical cables, for insuring the functioning of device 110. Either an audible or visual indicator 190, such as a light, can be connected to current detector 184 for giving either a audible or visual indication of the level of charged airborne agent pickup.

In those cases wherein evacuation device 154 is exhausted into a room, evacuator 154 can be comprised of an ozone removal device 191, such as but not limited to a porous ozone decomposition catalyst of a material well known in the art that is placed in a flow path maintained in device 154 for decomposing ozone for forming breathable air. In this form of the invention, evacuator 154 can further comprised a blower xx and filter xx. In another form of the invention, evacuator device 154 is in the form of an airborne agent collector/destruction device as described in the present invention.

In another form of the invention, charged particle source 112 is comprised of a spray device of a type well known in the art for producing charged cloud 116 in the form of a charged mist or one in accordance with the teachings of the present invention. Non-limiting examples of such spray devices can be found in U.S. Pat. Nos. 4,854,500 and 4,766,515 and references contained therein. The charged droplets or clusters can be comprised of:

a) a sterile salt solution for increasing the binding efficiency of the mist

b) a solution of disinfectant.

In the preceding embodiment of the invention, charged particles are created and directed over the transmissive surface by both the positioning of the charged particle source and space charge expansion effects and one or more focusing electrodes. The present invention also provides for protecting transmissive surfaces by focusing charged particles are the source of bioaerosol production.

The present invention provides for several configurations for focusing electrifying particles based upon the source of bioaerosol production. In one configuration, the electrifying source is positioned for transporting electrifying particles within at least a portion of the projection radius of the source of bioaerosols.

Now referring to FIG. 3, there is shown a method and apparatus for forming an expanding space charge cloud of electrifying particles within at least a portion of a projection radius of a source of bioaerosols for electrifying harmful airborne agents therein. The apparatus is a charged particle diffuser generally indicated by the numeral 210.

Charged particle diffuser 210 can operate as follows. One or more sources 211 and 212 of charged particles are positioned and actuated for both (1) producing a plurality of charged particles generally indicated by the numeral 218 and for (2) establishing an electrostatic field generally indicated by the arrows 213 having a gradient for dispersing charged particles 218 within at least a portion of a projection radius generally indicated by the line 219 of a source 220 of a plurality of bioaerosol agents generally indicated by the numeral 222 for forming charged bio-aerosol agents generally indicated by the numeral 234 therein. Charged particle source 211 or 212 can be positioned either on or off of source 220 as shown.

Bio-aerosol source 220 can be, but is not limited to, a high speed drill, a laser, saw, reamer, tissue cutting equipment or other tissue removing implement. In another form of the invention, tool 220 is in the form of an instrument that is of a type that is brought into physical contact with bodily fluids such as a suctioning or irrigation equipment. In the preferred form of the invention, source 211 is positioned on source 220 for directing charged particles 218 at the point of aerosol formation for dispelling a cloud generally indicated by the numeral 231 thereat.

The charged agents 234 are then electrostatically manipulated away from one or more transmissive surfaces 224 and 226 by one or more electrodes 221 and 223. In one form of the invention, the bioaerosol source such as a tool 220 or deflection plate thereon is provided with an electrostatic attractive member 225 for forming an attractive potential for attracting charged agents 234 thereto. Charged member 225 can be a portion of tool 220 or in the form of an electrode 227 attached thereto. In one form of the invention, at least a portion of tool 220 is grounded by a cable 231 for forming an attractive potential thereto. In still another form of the invention, a charger 235 imparts an active attractive potential of a polarity opposite to charged agents 234 for attracting charged agents 234 thereto by an electrical connection to a high voltage source. Charger 235 can be the opposite pole of an electrostatic generator used to charge charged particle source 212.

Attractive member 225 can be comprised of an electrode 227B covered with one or more removal sheets 229B and 231B. Sheets 229B and 231B can be comprised of an insulating material such as a polymeric material. Sheets 229B and 231B can be rendered antimicrobial by methods and reagents known in the art such as those described in European Patent Application number 0 136 900, and U.S. Pat. Nos. 5,069,907 and 4,721,511 or one in accordance with the teachings of the present invention. In the preferred for of the invention, sheets 229B and 231B are comprised of either (1) a tacky antimicrobial material such as described in U.S. Pat. No. 4,643,181 or (2) an impregnated material, as described hereafter, having antimicrobial properties when activated by, for example the ozone produced by source.

A current sensor 282 can be operatively connected to tool 220 for determining the level of current received for producing a feedback signal indicative of the rate of deposition of charged agents 234 on tool 220. The signal is then passed onto source through an electrical cable for maintaining a level of current within a predetermined range and/or for producing a visible or audible indicative signal of operation by use of a light or speaker for indicating the level of the current reaching tool 220. In the preferred form of the invention, the predetermined range of current is close to the output of charged particle sources 212. Current sensor 284 can be of a type well known in the art for detecting current.

In another form of the invention, charged particle source 211 is in the form of one or more ink jet ionizer for forming a cloud of electrifying particles.

In another form of the invention, a charged particle source 291 of charged particles is position on bio-aerosol generator 220 for directing charged particles at the user of generator 220 for electrifying particles projected thereat.

In the second configuration, the electrifying source is positioned for passing electrifying particles within an area where a medical procedure takes place.

Now referring to FIG. 4, there is shown a method and apparatus for forming a expanding space charge cloud of electrifying particles within an area where a medical procedure takes place for electrifying harmful airborne agents therein. The apparatus is a charged particle area diffuser generally indicated by the numeral 310.

In the operation of the charged particle area diffuser 310 a charged particle source 312 is positioned for diffusing a plurality of electrifying particles generally indicated by the numeral 318 above an area generally indicated by the numeral 341 where a medical procedure takes place for electrifying one or more infectious airborne agents 313 created therein for forming charged infectious airborne agents 315 and for forming an electrohydrodynamic environment therein. In one form of the invention, source 312 may be placed in above area 341 on, for example a light 343, which may be in the form of an aiming light, for directing electrifying particles 318 down towards medical procedure area 341.

In another form of the invention, source 312 is positioned on an adjustable surgical arm 351 of a type well known in the art for positioning source 312 where needed.

A charge sensor 382 can be mounted on a patient support device 399 such as a bed or operating table for monitoring the level charge in area 341.

In one form of the invention, charged infectious airborne agents are collected on electrode 351 in the form of a culture medium for subsequent analysis of the bio-particles collected thereon.

In another form of the invention, charged agents 315 can be collected on one or more wall portions 345 and 347. Wall portions, 345 and 347 can be either grounded or charged through a cable 361 for forming an attractive potential thereto.

In the third configuration, the electrifying source is positioned for diffusing electrifying particles with the vision field of a transmissive surface.

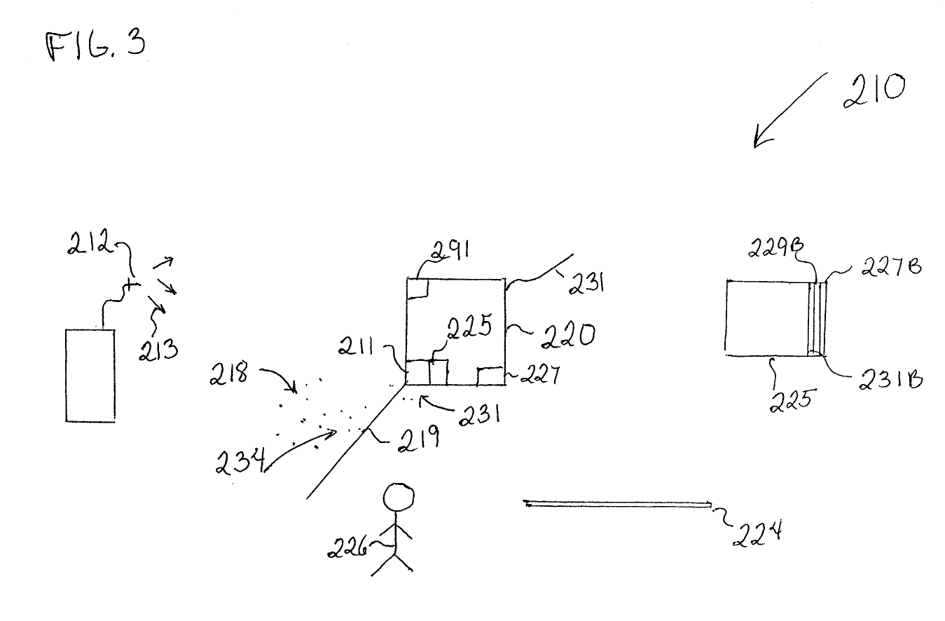

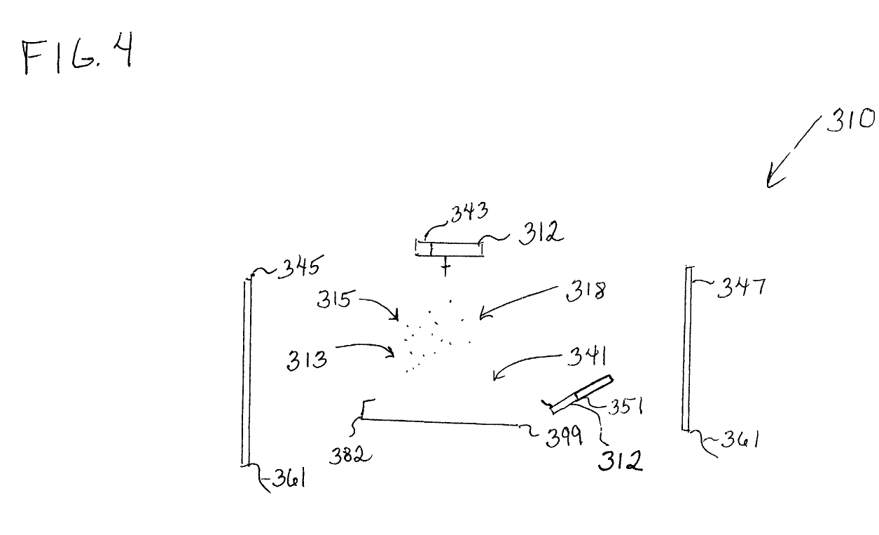

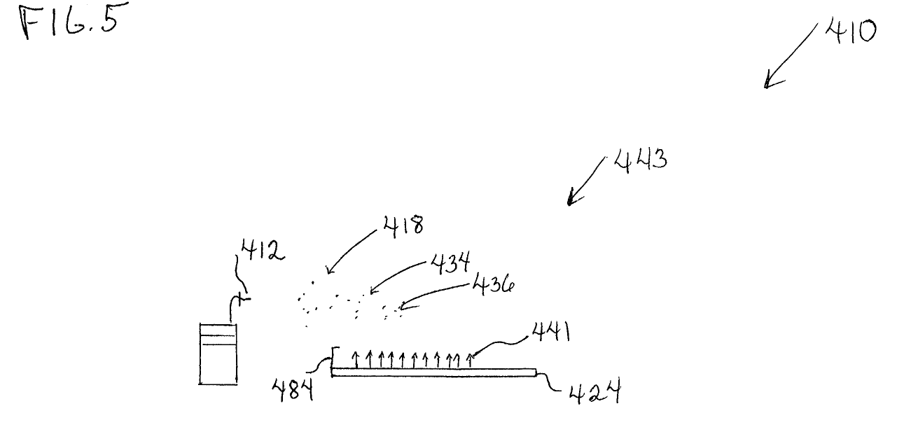

Now referring to FIG. 5, there is shown a method and apparatus for forming a cloud of electrifying particles within the vision field of a transmissive surface for electrifying harmful airborne agents therein. The apparatus is a charged particle field diffuser generally indicated by the numeral 410. This form of the invention, is particularly useful protecting transmissive surface 424 from a plurality of infectious airborne agents 434 distributed throughout an enclosed space generally indicated by the numeral 443. Enclosed space 443 can be either a building or part thereof or the inside of a military vehicle such as a ground draft, aircraft, spacecraft, marine craft and the like. In particular, enclosed space 443 collection be a hospital, medical or dental consultation room, laboratory, drug manufacturing plant or a food production facility and the like.

In the operation of the charged particle field diffuser 410 a charged particle source 412 is positioned for diffusing a plurality of electrifying particles 418 within a vision field generally indicated by the arrows 441 of a transmissive surface 424. Vison field 441 is the region of space that can be defined by what would be seen by transmissive surface 424 if it had eyes.

A charge sensor 484 of a type well known in the art can be used can be positioned in vision field 441 for producing feedback signals indicative of that charge to charged particle source 412 for maintaining the charge in that region within a predetermined range by for example the attachment of senor 484 onto transmissive surface 424.

Once electrifying particles 418 have combined with infectious airborne agents 434 for forming a plurality of charged infectious airborne agents generally indicated by the numeral 436 the charged infectious airborne agents are then electrostatically manipulated by one or more voltage driven electrodes for protecting transmissive surface 424 from harmful airborne agents 434. In one form of the invention transmissive surface 424 itself is used as an electrode for repelling charged infectious airborne agents or charged flow.

In another form of the invention, transmissive surface is comprised of a surface on an inanimate object. In this form of the invention, transmissive surface is of a type wherein the protecting of such inanimate surfaces from toxic and/or infectious airborne agents for health and safety reasons is desirable.

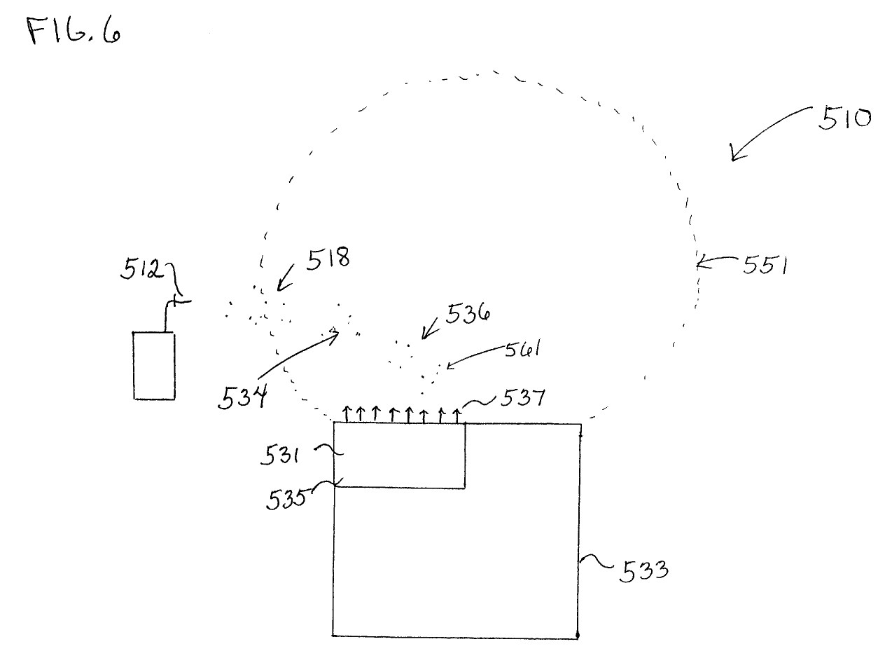

Now referring to FIG. 6, there is shown a method and apparatus for protecting transmissive surface on inanimate objects from infectious airborne agents in the form of bacteria, viruses or aerosols or droplets carrying the same. Inanimate object can be comprised of one or more of the following materials; polymeric materials, glass, rubber, metal or organic matter such as but not limited to food matter or pharmaceuticals. In particular, object can be medical equipment, food and food handling equipment, drugs and drug handling equipment. The apparatus is an electret deflector generally indicated by the numeral 510.

Electret deflector 510 can operate as now described. A surface area 531 on an inanimate object 533 is covered with an electret material 535 for forming a permanent repulsive electrostatic field generally indicated by the arrows 537 therefrom. Electret material 535 can be attached to object 533 by an adhesive strip (not shown).

A charged particle source 512 is then actuated for forming a plurality of charged particles generally indicated by the numeral 518 for electrifying a plurality of harmful airborne agents generally indicated by the numeral 534 contained in a sea of harmful or infectious airborne agents generally indicated by the numeral 551 that is contacted with surface 535 for forming a plurality of charged harmful airborne agents generally indicated by the numeral 536 therein for subsequent repulsion by electret 535.

In one form of the invention, object 533 is comprised of a mask portion for filtering air. In this form of the invention, electret 535 can be porous in nature.

In another form of the invention, electret 535 further comprises an antimicrobial substance 555 functionally located on a surface 535 thereon. In this form of the invention, the electrostatic repulsion of a plurality of dust particles 561 from surface 531 also aids in maintaining surface 531 free of infectious airborne agents by constantly exposing surface 531 to the antimicrobial action of material 555.

In another form of the invention, one or more electrodes are used to deflect harmful airborne agents away from a transmissive surface. The electrode can be in the form of a “hard” electrode or an “air” electrode.

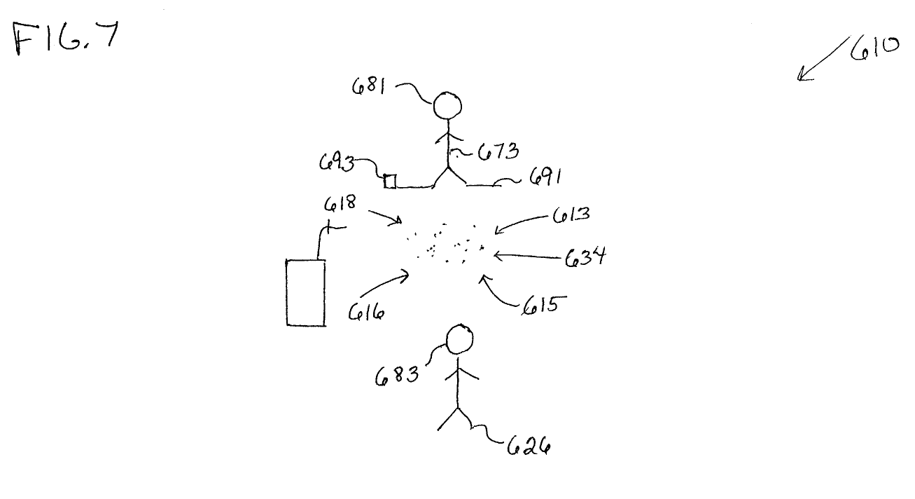

Now referring to FIG. 7 there is shown a method and apparatus for protecting a transmissive surface by the use of a repulsive air electrode. The apparatus is a repulsive air electrode generally indicated by the numeral 610. The apparatus is useful for protecting transmissive surfaces that for practical or safety reason cannot be electrostatically charged. The apparatus is also useful in protecting two or more transmissive surfaces that can pass or transmit harmful airborne agents therebetween such as for example a transmissive surface located on a patient and the other on a medical staff member.

The repulsive air electrode 610 can operate as follows. First, a charged particle source 612 is actuated for producing an expanding space charged cloud generally indicated by the numeral 613 between a source of infectious airborne agents 763 and a transmissive surface 626 for forming a repulsive air electrode generally indicated by the numeral 615 therebetween. Source of infectious airborne agents 673 can be a patient or medical staff member.

A plurality of charged particles 618 produced by source 612 combine with or otherwise electrify a plurality of harmful airborne agents 616 contained in or generated by infectious airborne agent source 673 for forming charged infectious airborne agents generally indicated by the numeral 634. The electrostatic field generated by air electrode 615 repels charged infectious airborne agents 634 away from surface 626 for protecting surface 626 from infectious airborne agents.

In another form of the invention, space charged cloud 613 is produced between two sources of infectious airborne agents 681 and 683 for protecting sources 681 and 683 from each other. In this form of the invention, sources 681 and 683 can be a medical staff member and a patient.

In one form of the invention, an attractive potential can be placed on source 673 by either a grounding cable 691 or by a charger 693 for charging source 673 with an attractive charge.

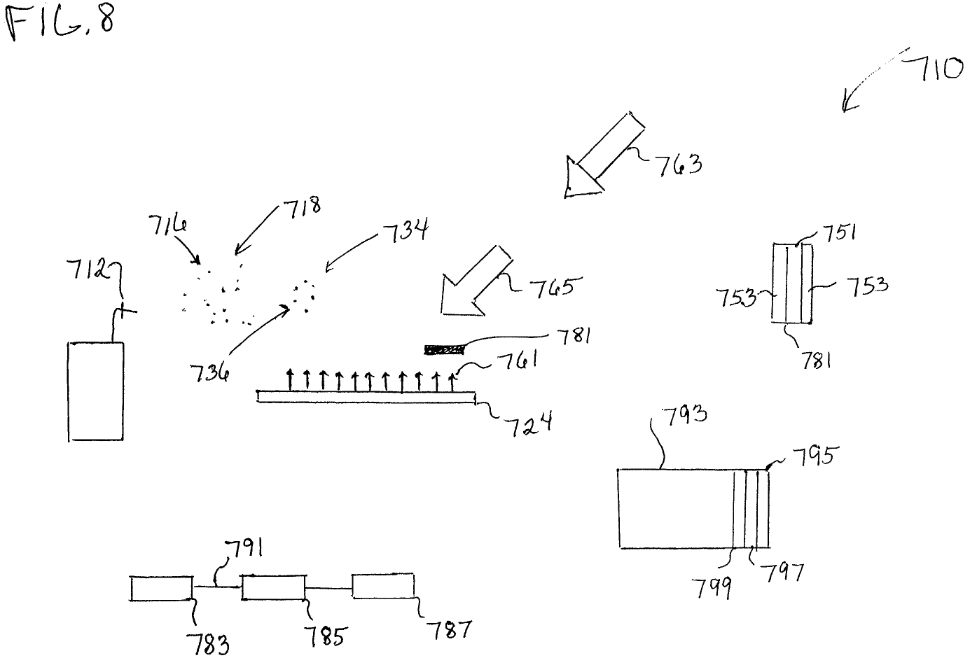

Now referring to FIG. 8 there is shown a method and apparatus for protecting a transmissive surface by the use of an “hard” electrode. The apparatus is an airborne agent deflector generally indicated by the numeral 710. The apparatus is useful for protecting transmissive surfaces that for practical or safety reason cannot be electrostatically charged.

The airborne agents deflector 710 operates as follows. One or more charged particle sources 712 are actuated for producing a charged particle cloud generally indicated by the numeral 718 comprised of a plurality of unipolar charged particles 716. Charged particle source 712 is positioned for forming cloud 718 within a vision field generally indicated by the arrow 761 of a transmissive surface 724. Charged particles 716 combine with one or more harmful airborne agents generally indicated by the numeral 734 in vision field 761 for imparting a charge thereto for forming a plurality of charged harmful airborne agents generally indicated by the numeral 736 and for charging one or more fluid flows 763 moving with field 761 for forming one or more charged flows generally indicated by the arrow 765.

An electrode element 781 is then actuated for deflecting the charged harmful airborne agents 736 and/or charged flows 765. In one form of the invention, electrode 781 is in the form of a “hard electrode”. Electrode element 781 can be comprised of either (1) many conducting elements 783, 785 and 787 with a plurality of surge limiting resistors 791 therebetween for preventing the delivery of a discomforting charge to a grounded person upon contact or electrode element 781 can be comprised of a high resistive element 793 comprised of a material such as but not limited to doped plastic.

In one form of the invention, electrode element 793 is comprised of several layers of material 795, 797 and 799 having increasing resistivities for ensuring charging of an upper layer 799 thereof. Low surge layer 799 can have an electrical resistance of between 10⁶ to 10¹² ohms/cm² for preventing any significant amount of charge from flowing abruptly therefrom when touched. In particular, low surge layer can be, and in now way limiting the present invention to any particular high resistance material, POLYTORN (TM) made by the B. F. Goodrich Company. Layer 797 can be comprised of a material having an electrical resistance of less than 106 ohms/cm² for charging layer 799. Inner material 795 can be directly attached to a high voltage generator or similar device for creating a directing electrostatic charge on layer 799.

In still another form of the invention, electrode element 781 is comprised of a conductor 751 covered with a material 753 comprised of a semi-conductive, or electrical resistance material such as cement, plaster composition or the like.

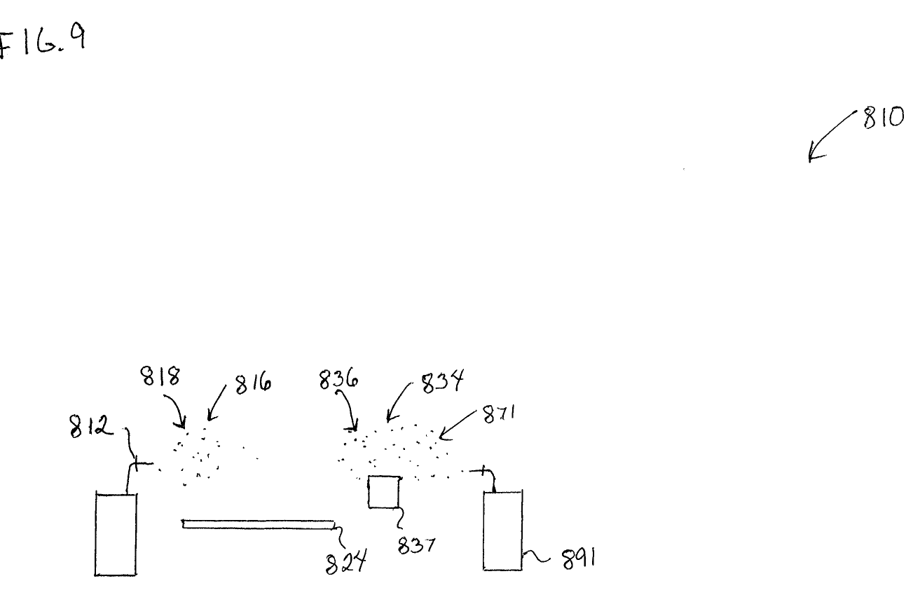

Now referring to FIG. 9, there is shown a method and apparatus for protecting a transmissive surface by a attractive electrostatic field. The apparatus is a harmful airborne agent attractor generally indicated by the numeral 810.

The harmful airborne agent attractor 810 operates as follows. One or more charged particle sources 812 are actuated for producing an expanding charged particle cloud generally indicated by the numeral 816 comprised of a plurality of unipolar charged particles 818. Expanding cloud 816 of particles 818 function to (1) electrify a plurality of harmful airborne agents generally indicated by the numeral 834 for imparting a charge thereto for forming charged harmful airborne agents generally indicated by the numeral 836 and (2) for repelling the thus charged agents 836 away from an exposed surface that may be comprised of transmissive surface 824. Harmful airborne agents 834 can be of a type generated by an aerosol generator 837.

An electrostatic charge is formed by an air electrode generally indicated by the numeral 871 for attracting charged harmful airborne agents 836 from an exposed surface 824 to be protected. Air electrode 871 attracts can be positioned for attracting charged agents 836 from regions adjacent to surface 824 for protecting surface 824.

In one form of the invention, electrode 871 is in the form of a stationary air electrode formed by a high space charge region of a polarity for attracting charged harmful airborne agents 836. Air electrode 871 can be formed by a second charged particle source 891 that may be connected to an opposite pole of an electrostatic generator (not shown).

Surface 824 can also be charged by a charger for establishing a combined electrostatic field for both repelling and attracting charged harmful airborne agents 836 away from surface 824.

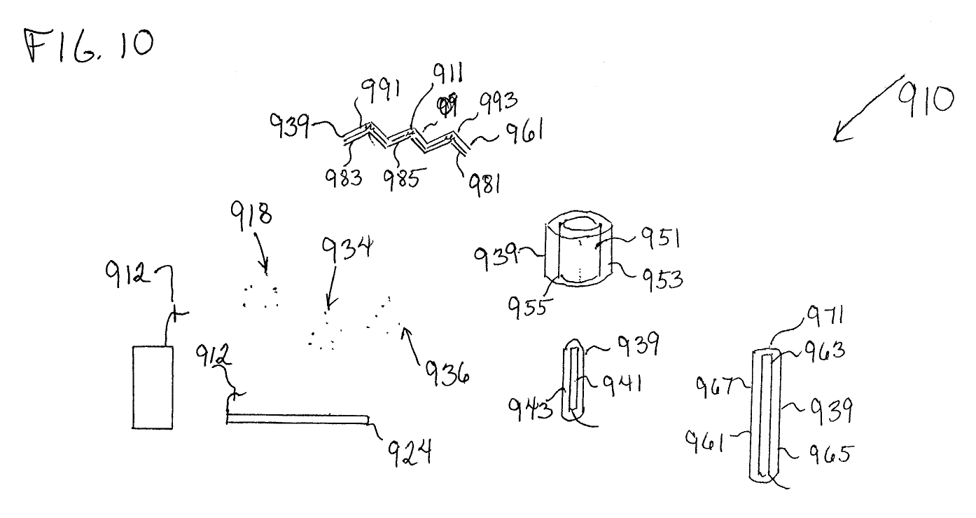

Now referring to FIG. 10, there is shown a schematic of a method and apparatus for protecting a transmissive surface by an attractive electrostatic field generated by one or more “hard electrodes”. The apparatus is a harmful airborne agents electrode attractor generally indicated by the numeral 910.

Electrode attractor 910 can operate as follows. A charged particle source 912 is actuated for producing an expanding charged particle cloud generally indicated by the numeral 918 comprised of a plurality of unipolar charged particles 918. Expanding cloud 918 of particles 918 gather up a plurality of harmful airborne agents generally indicated by the numeral 834 as a plurality of charged harmful airborne agents generally indicated by the numeral 936 as cloud 918 continues to expand away from a exposed surface 924 for protecting surface 924 from harmful airborne agents 934. Charged particle source 912 can be positioned on exposed surface 924 for expanding cloud 918 therefrom.

In another form of the invention, an electrode 939 is positioned for both attracting and receiving charged harmful airborne agents 936. Electrode 939 can be of a type that can be operatively connected to the opposite pole of an electrostatic generator which powers charged particle source 912.

Electrode 939 can be comprised of a charged member 941 that is covered with a tacky film 943. Tacky film 943 can be comprised of a dried solution of, for example, an aqueous latex composition containing carboxylated butadiene stryene polymers.

In one form of the invention, electrode 939 is comprised of a charged member 951 that is covered with one or more sheets 953 and 955 of an insulating material. In this way, when harmful airborne agents 934 have built up on outer most sheet 955 it can be removed for exposing the next ready to use sheet 953. Sheets 953, 955 etc. can be wrapped around member 951 much like toilet paper.

In yet another form of the invention, electrode 939 can be easily disassembled or detached from electrostatic generator by a screw attachment thereto for replacement or cleaning. Thus, the time required for on site cleaning can be shortened.

In still another form of the invention, attractive electrode 939 is comprised of a wall panel 961. Wall panel 961 can be comprised of an electrically conductive sheet member 963 disposed between a pair of electrically non-conductive insulation sheets 965 and 967 which are boned together. Conductive sheet 963 may be coupled to a high voltage source for imparting an electrostatic charge of between 1,000 to 30,000 volts and a charging currrent of less than 1 mA. Wall panel 961 may be of rigid planar form as shown by number 971, or may be constructed as an accordion fold curtain 981.

Accordion curtain 981 can be comprised of a plurality of flexible insulation sheets 983, 985 etc. and conductive sheets 991, 993 etc. A plurality of surge limiting resistors 911 can be couple conductive sheets 991, 993 etc. together for reducing the shock hazard.

For an explanation of the phenomena utilized in the protection of postal office workers reference may be had to U.S. Pat. No. 6,068,199 and European Pat. No. 2018627B. However, for an understanding of the invention, more fully described hereinafter, the following explanatory remarks will be sufficient.

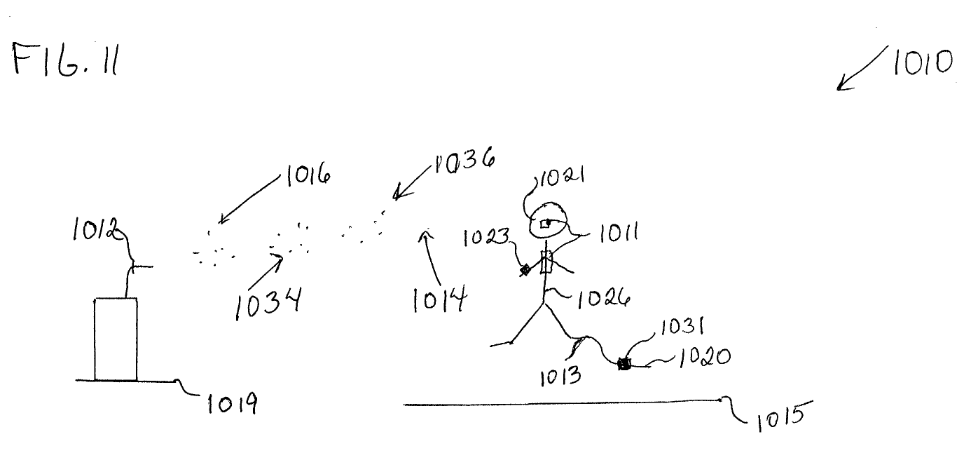

Now referring to FIG. 11, there is shown a method and apparatus for protecting an individual from inhalation anthrax. The apparatus is a sinus precipitator generally indicated by the numeral 1010.

Sinus precipitator 1010 can operate as follows. First, a charged particle source 1012 is positioned and activated for forming a plurality of charged particles generally indicated by the numeral 1016 in a volume of inhalation air generally indicated by the numeral 1014. Charged particles 1016 combine with or otherwise transfer their charge to a plurality of infectious airborne agents generally indicated by the numeral 1034 comprised of anthrax for forming a plurality of charged infectious airborne agents generally indicated by the numeral 1036. Charged particle source 1012 can be mounted on a desk, table or other support device 1019 for directing charged particles 1016 at one or more individuals 1026. In the preferred form of the invention, charged particle source 1012 is directed at a face portion 1021 of individual 1026.

Particles 1034 are charged for depositing at least a portion of charged infectious airborne agents 1036 in a non-lung portion of individual 1026, such as but not limited to the face and upper respiratory tack 1011 of individual 1026. An attractive potential can be maintained on individual xx by use of an electrical conductor 1020 that is either (1) grounded or (2) maintained at an attractive voltage by attachment to a charger xx for continuously depositing charged infectious airborne agents 1036 in upper respiratory track 1011 of individual 1026 for protecting individual xx from inhalation anthrax. Electrical conductor 1011 can comprise a conductive shoe portion 1013 of a type used to ground semiconductor workers. A conductive floor portion 1015 and/or chair (not shown) may be used for aiding in grounding individual 1026.

A current detector 1031 can be in electrical contact with conductor 1020 for monitoring the level of deposition of charged agents 1036. Current detector 1021 can be electrically connected to an audible or visual indicator 1023, such as a microphone and/or light for indicating the level of deposition. Detector 1031 can be placed on individual 1026 as shown.

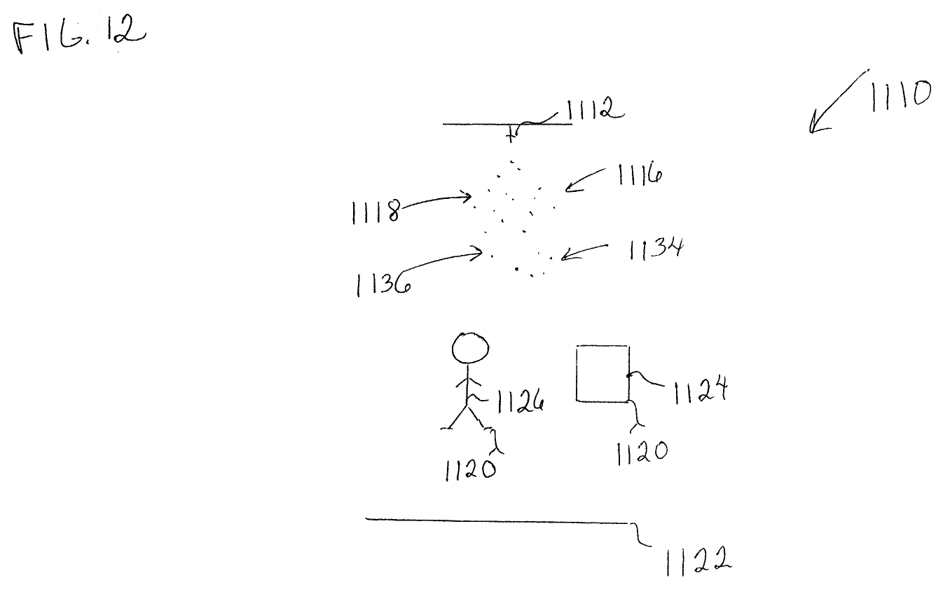

Now referring to FIG. 12, there is shown a method and apparatus for reducing the deposition of airborne anthrax onto the lungs of a postal worker. The apparatus is an airborne anthrax charger generally indicated by the numeral 1110.

The airborne anthrax charger 1110 operates as now described. First, a charged particle source 1112 is actuated for forming a descending cloud of charged particles generally indicated by the numeral 1116. In the preferred form of the invention, charged particle source 1112 is of a type for producing a plurality of charged particles generally indicated by the numeral 1118 in the form of droplets the size of which are electrostatically manipulative. A salt may be added to the droplets for better collection efficiency.

Charged particles 1118 combine with or otherwise transfer their charge to a plurality of infectious airborne agents 1134 comprised of anthrax for forming a plurality of charged infectious airborne agents generally indicated by the numeral 1136.

Charged particles 1136 are then collected on one or more letter transporters 1124 and 1126. Transporters 1124 and 1126 can be given an attractive potential through a cable 1120.

In another form of the invention, charged particles 1136 are also collected on a conductive floor portion 1122.

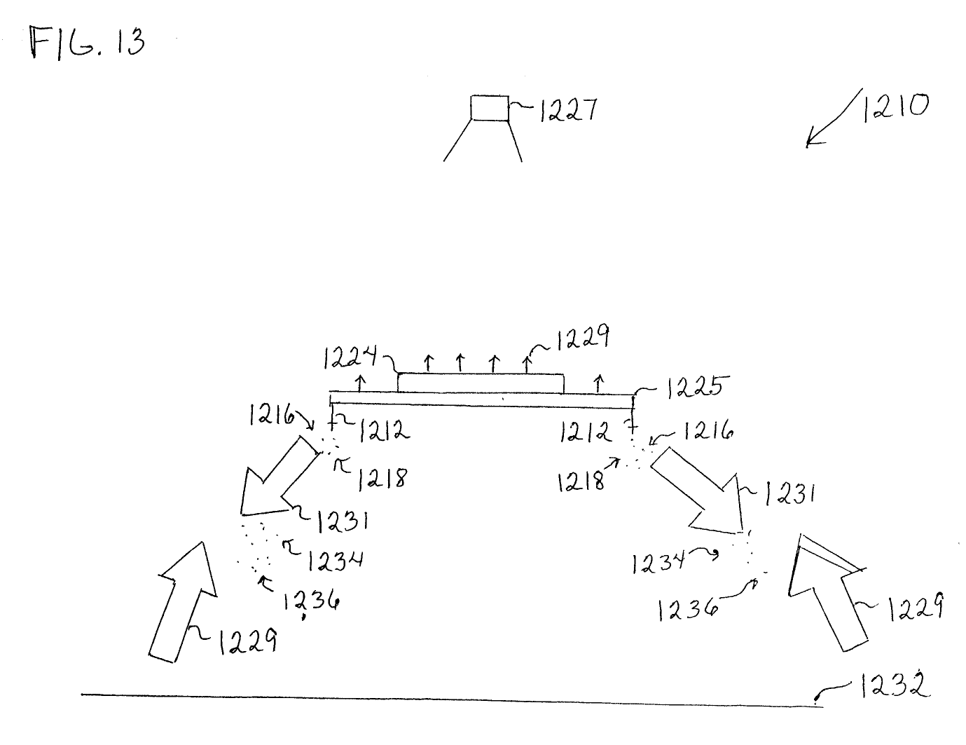

Now referring to FIG. 13, there is shown a schematic of a method and apparatus for protecting an exposed surface from harmful airborne agents contained in convective flows created by the illumination of the surface. The apparatus is a convective flow purifier generally indicated by the numeral 1210.

Convective flow purifier 1210 can operates as follows. First, a exposed surface 1224 supported on a platform 1225 is illuminated by a source of electromagnetic radiation 1227 and thereby creating an upwardly moving convective flow generally indicated by the arrows 1229 containing a plurality of harmful airborne agents 1234. Platform 1225 can be a support device, such as a surgical table, a bed, or chair of a type use in patient care. Radiation source 1227 can be comprised of one or more lights of a type commonly used in a medical procedure or for drying objects.

One or more charged particle source 1212 are then actuated for forming an expanding charged cloud generally indicated by the numeral 1218 comprised of a plurality of charged particles generally indicated by the numeral 1216. Expanding cloud 1218 is directed, by for example the positioning of source 1212 on support 1225, for passing cloud 1218 through flow 1229 in a counter current direction to convective flow as shown by arrow 1231.

As charged particles 1216 pass through flow 1229 they combine with or otherwise transfer their charge to a plurality of harmful airborne agents generally indicated by the numeral 1234 for forming a plurality of charged particles generally indicated by the numeral 1236.

Charged particles 1236 are directed by expanding cloud 1218 away form exposed surface 1224 for protecting surface 1224 from harmful airborne agents 1234.

A charged member 1232, such as a grounded floor portion, can be provided for receiving charged harmful airborne agents 1236.

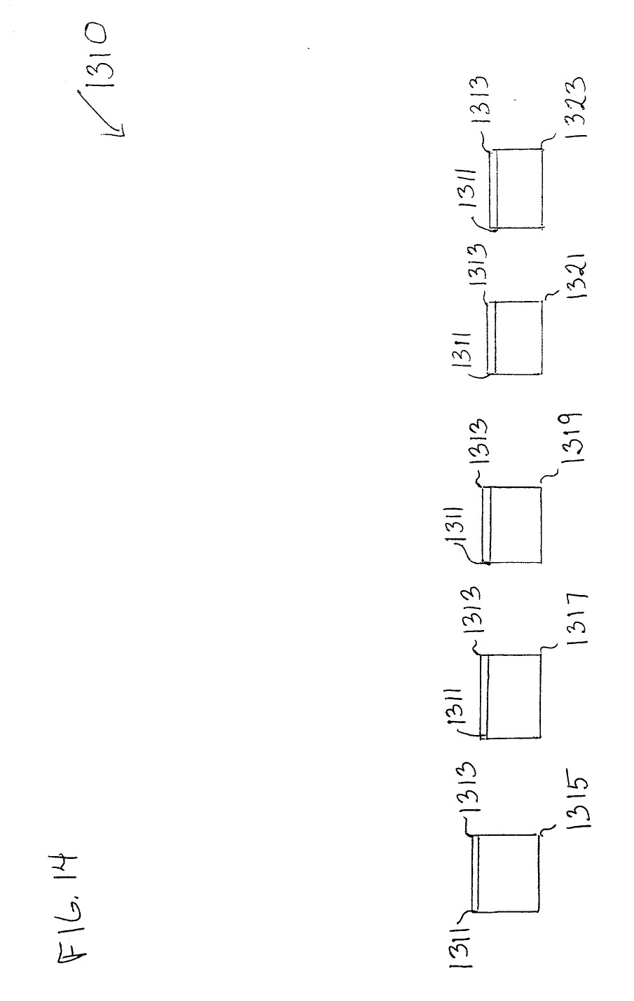

Now referring to FIG. 14, there is shown directing electrodes 1310 useful in accordance with the teachings of the present invention.

Directing electrodes 1311 can be comprised of an electret material 1313. Material 1313 can be formed into: (1) outer covering of a scrub cap 1315 for collecting charged infectious airborne agents thereto, (2) a mask 1317 for repelling both charged infectious airborne agents and charged flows away therefrom mask 1317 may be comprised of a layer of material in the form of an ozone decomposition catalyst and a support layer which may be made of cloth or paper, mask 1317 can be of a type adapted to enclose at least the nose, mouth and chin areas of the wear's face. A sealing means of a type well in the art can be provided for sealing the mask 1317 to the wear's face to form an air-tight chamber. An adjustable mounting means such as a strap can be secured to mask 1317 for securing mask 1317 to the wear's head. (3) at least a portion of a gown 1319 for attracting charged harmful airborne agents thereto, (4) a plurality of shoe coverings 1319 for attracting charged infectious airborne agents thereto, (5) a plurality of gloves 1321 for repelling charged infectious airborne agents therefrom, or be (6) in the form of disposable wearable plates 1323 for attracting charged harmful airborne agents thereto.

For an explanation of the electrostatic charging phenomena utilized in the cryogenic ionizer reference may be had to U.S. Pat. Nos. 5,765,394 and 3,786,644. However, for an understanding of the invention, more fully described hereinafter, the following explanatory remarks will be sufficient.

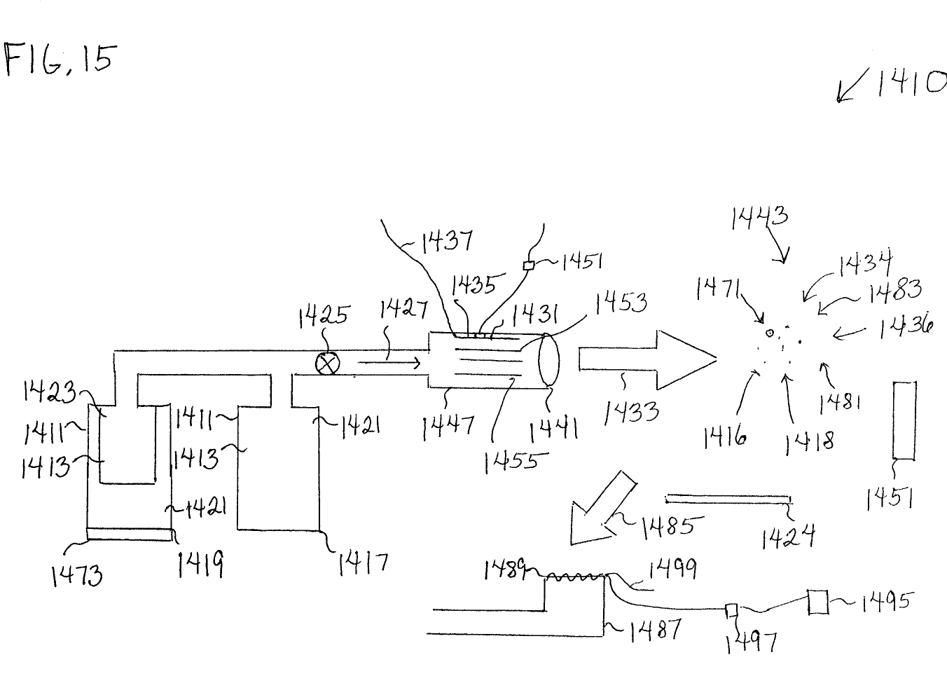

Now referring to FIG. 15, there is shown a schematic of a method and apparatus for transforming airborne agents into charged electrostatically manipulative particles and the removal of the same from air. The apparatus is a cryogenic ionizer generally indicated by the numeral 1410.

The cryogenic ionizer 1410 can operate as follows. A source 1411 of liquid insulative material 1413 is provided in a container 1415. Container 1415 can be one or more types of pressurized canisters 1417 and 1419. Canister 1417 can be in the form of a pressurized cylinder 1421 of liquid, such as a carbon dioxide or fluorinated hydrocarbon or canister 1419 can be comprised of a pressurized gas region 1421 and liquid region 1423. Insulative material 1413 can be comprised of, for example and in no way limiting the present invention to any particular insulative material, carbon dioxide, ultra-high purity water, a non-toxic hydrocarbon or fluorine containing hydrocarbon which can be of a type commonly used for as refrigerants. In particular, insulative material 1413 can be a fluorocarbon compound having a ratio of fluorine to fluorine and hydrogen which is greater than about 0.75. More particularly, material 1413 can be from a group comprised of: tetrafluoromethane; hexafluoroethane; octafluoropropane; chlorotrifluromethane; chloropentafluoroethane; dichlorodifluoromethane; 1,2-dichlorotetrafluoroethane; 1,1,1,2,3,3,3,-heptafluoropropane; pentafluoroethane; 2-chloro-1,1,1,2-tetrafluoroethane; trifluoromethane; 1,1,1,2,3,3-hexafluoropropane; and 2,2-dichloro-1,1,1-trifluoroethane.

A valve 1425 is then actuated for forming a flow generally indicated by the arrow 1427 of material 1413. Valve 1425 can be a solenoid valve for forming either a continuous or intermittent flow of material 1413.

Flow 1427 is then directed against a charging member 1431 at least one time for tribo-electrically charging flow 1427 with an electrostatic charge for forming a charged flow of material generally indicated by the arrow 1433. Charging member 1431 can be comprised of an electrically conductive material 1435 that is grounded by use of a cable 1437. Depending upon the tribo-electric properties of flow material 1413 conductive material 1435 can be chosen, from a tribo-electric table well known in the art of electrostatics, for either negatively or positively charging material 1413.

Charged flow of material 1433 is then directed and passed through an outlet 1441 for forming and directing a charged cloud generally indicated by the numeral 1418 of a plurality of electrifying particles generally indicated by the numeral 1416 into an environment generally indicated by the numeral 1443 containing a plurality of infectious airborne agents generally indicated by the numeral 1434 for electrifying agents 1434 for forming a plurality of charged agents 1436. Charged flow 1433 can be directed by charging member 1431 shaped in the form of a conduit or passageway 1447 for both electrifying material 1413 and for directing flow 1433 to a point of use of, for example a tool 1451. Conduit 1447 can be comprised of a plurality of channels 1453 and 1455 etc. for increasing the charge generating surface area of member 1431.

In one form of the invention, charged materials 1413 such as charged carbon dioxide snow or similarly charged cryogenic material, such as liquid nitrogen and the like, are passed through outlet 1441 for both the electrification of agents 1434 and their enlargement due to the condensation processes for forming a plurality of enlarged infectious airborne agents generally indicated by the numeral 1471 comprised of a unipolar charge and having a size amenable to electrostatic manipulation. In those cases wherein material 1413 is comprised of water and the like, a cooler 1473 can be provided in thermal contact with source 1411 for cooling liquid material 1413 for forming a cold cloud generally indicated by the numeral 1481 of cold electrifying particles generally indicated by the numeral 1483.

The amount of charge generated can be monitored by use of a current detector 1451, of a type well known in the art, that is in electrical contact with member 1431 for measuring the amount of electrostatic charge transfer occurring.

Charged agents 1436 or 1483 are then manipulated by one or more fields, such as an electric or magnetic field, for protecting a transmissive surface 1424 that is in fluid contact with environment 1443.

In one form of the invention, charged agents 1436 or 1483 are manipulated into an evacuation induced flow generally indicated by the arrow 1485 for removing agents 1436 or 1483 from environment 1443. In the preferred form of the invention, charged agents 1436 or 1483 are electrostatically manipulated into flow 1485 use of an evacuation source 1487 having an electrostatically attractive member 1489 positioned for conveying charged agents 1436 or 1483 into flow 1485. Attractive member 1489 can have a lessor or opposite charge than cloud 1418 applied thereto through a second cable 1499.

Evacuation source 1487 can be provided with one or disposable liners on the intake means for maintaining a contamination free environment. Or intake means can be comprised of an entirely disposable unit. In addition, charged member 1489 can be releasably attached to evacuation source 1487 by clips for ease of disposal.

Evacuation source 1487 can further comprise a filter and/or radiation source for sterilizing the flow before being exhausted at a point remote form the operating area. Evacuation source 1487 can be rollable portable and door way passable and be provided with a positional support for fixing the position thereof.

A second current detector 1497 can be electrically attached to member 1489 for measuring the uptake of charged agents 1436 or 1483. An analyzer 1495 that is in electrical contact with detectors 1497 and 1451 can be used to monitor the over charging and collection process for generating an audible or visual indication of the level of performance and for providing for feedback signals to charged particle source.

For those materials 1413, such as but not limited to carbon dioxide, that are released at high pressures, a decelerator 1455 can be attached to outlet 1441 for decelerating charged flow 1433 for forming a decelerated charged flow generally indicated by the arrow 1455 for electrifying infectious airborne agents 1434 without creating unduly large incidental flows. Decelerator can be of a type as described in U.S. Pat. No. 5,765,394.

In another form of the invention, material 1413 is repeatedly circulated past charged member 1431 through use of a by pass conduit (not shown) for increasing the electrostatic charge applied to material 1413 before its release.

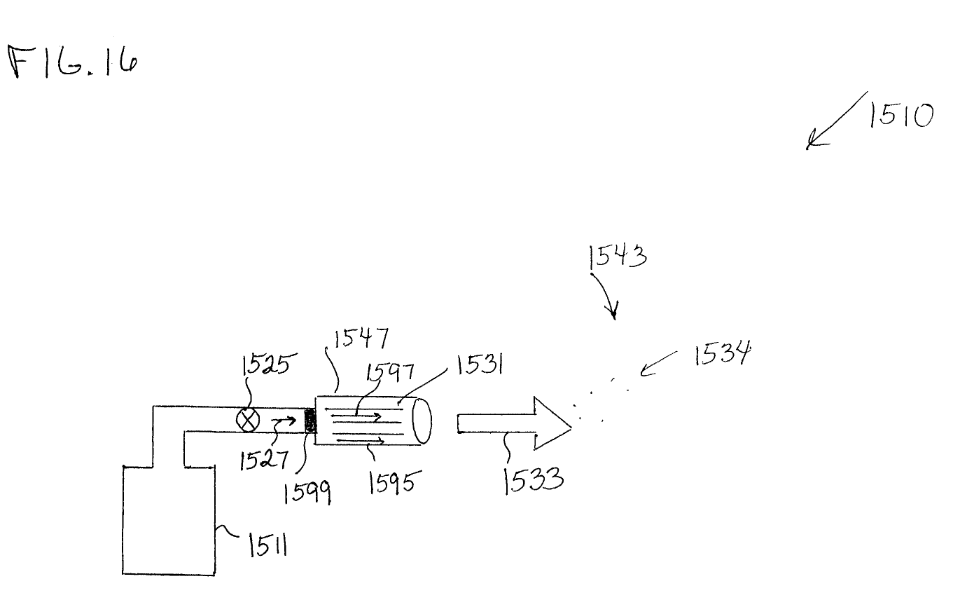

Now referring to FIG. 16, there is shown a cryogenic ionizer for forming a plurality of charged particles from finely divided carbon dioxide snow. The apparatus is a porous ionizer generally indicated by the numeral 1510.

The porous ionizer 1510 can operate as follows. A source 1511 of carbon dioxide is provided in a pressurized container 1515 at 300 psig or thereabout.

A valve 1525 is then actuated for forming a flow generally indicated by the arrow of carbon dioxide 1527. Valve 1525 can be a solenoid valve for forming either a continuous or intermittent flow.

Flow 1527 is then passed through a porous disk divider 1599 for dividing flow 1527 into a plurality of flowing streams of carbon dioxide snow generally indicated by the arrows 1597 and 1595 in a conduit 1547 of intermediate pressure and containing one or more charging members 1531 for charging the finely divided snow. Disk divider 1599 can be comprised of stainless steal. Charging members 1531 can be comprised of an tribo-electric electron donor material such as copper.

The charged flow 1533 is then directed and passed into an environment 1543 at or near atmospheric pressure and containing a plurality of infectious airborne agents generally indicated by the numeral 1534 therein for both electrifying and enlarging agents 1534 for the subsequent manipulation.

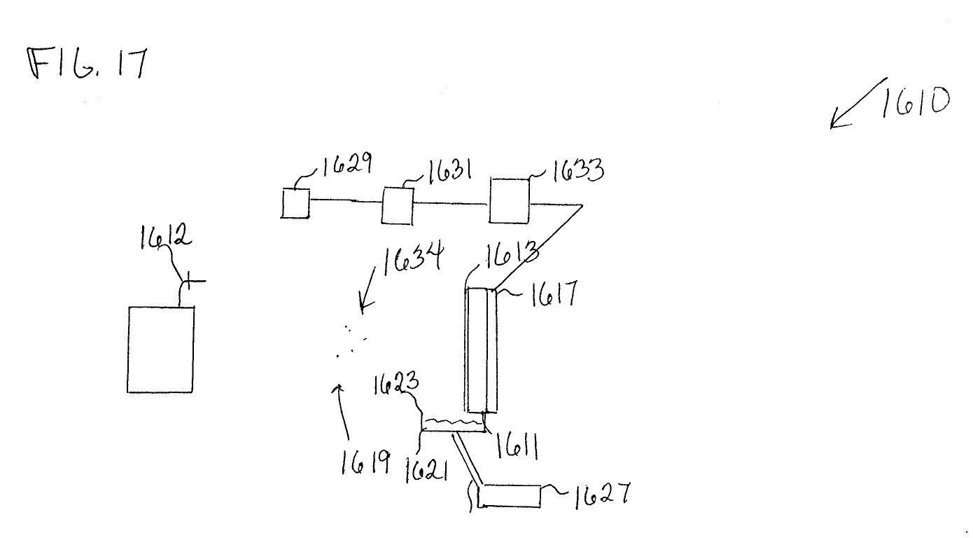

Now referring to FIG. 17, there is shown a schematic of a self-cleaning electrode generally indicated by the numeral 1610. The self-cleaning or sweating electrode is useful for the continuous collection of airborne agents by electrostatic means for both the analysis and purification of gases.

The self-cleaning electrode 1610 can operate as follows. First, a charged member 1611 is provided for attracting a plurality of charged airborne agents generally indicated by the numeral 1634 thereto for forming an electrostatically deposited material 1613 thereon. Charged member 1611 can be comprised of: an electret material; (2) a frictionally charged polymer; or a voltage driven electrode. In the preferred form of the invention, charged member 1611 is comprised of a anti-corrosive material, such as silver, copper, gold, plastic, and the like. Charged airborne agents 1634 can be comprised of either naturally occurring charged particles or can be manufactured by use of an ionizer 1612 in fluid communication with charged member 1611.

A cooler 1617 is provided in thermal contact with charged member 1617. Cooler 1617 can be, for example, either a flow type heat exchanger or a Peltier device. Cooler 1617 is then actuated for cooling charged member 1611 below the dew point of a gas generally indicated by the numeral 19 surrounding charged member 1611 for condensing atmospheric moisture on charged member 1611 for removing deposited material 1613 therefrom in the form of a material solution 1621.

In one form of the invention, material solution 1621 can then collected in a collection trough 1623. Collection trough 1623 can be have a plastic or other non-conductive conduit or tube 1625 fluidly connected thereto for removing material solution 1621 from trough 1623 for disposal or analysis by an analyzer 1627.

A humidity detector 1629 and temperature gauge 1631 can be provided for determining the dew point of gas 1619 for sending a signal to a thermostat 1633 in electrical connection with cooler 1617 for either increasing or decreasing the cooling rate.

In another form of the invention, material solution 1621 is dropped off a hanging charged member (not shown) and then collected on a grounded collection screen for increasing the safety of operation.

In another form of the invention, a humidifier humidifies air 19 for increasing the rate of sweating of electrode.

The sweating electrode can also be used in an electrostatic air cleaner.

For an explanation of the electrostatic charging phenomena utilized in the steam ionizer reference may be had to Phil Mag., 3^{rd} series, vol. Xviii pgs. 93, 95 and 100. However, for an understanding of the invention, more fully described hereinafter, the following explanatory remarks will be sufficient.

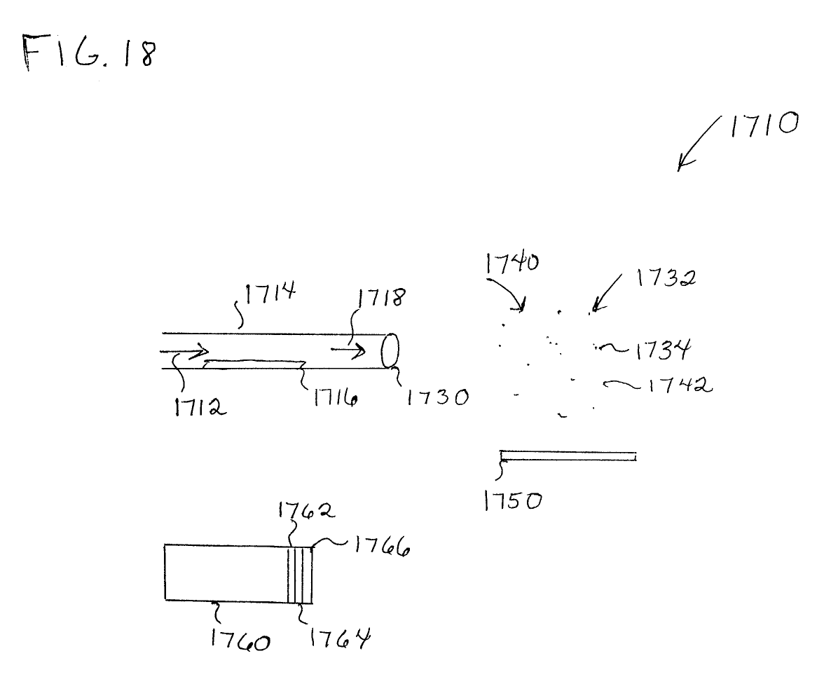

Now referring to FIG. 18, there is shown a schematic of steam ionizer for both electrifying and enlarging infectious airborne agents for their subsequent electrostatic manipulation. The apparatus is a steam ionizer generally indicated by the numeral 1710.

Steam ionizer 1710 can operate as now described. First, a flow generally indicated by the arrow 1712 of dry steam is passed through a dielectric conduit 1714 and passed through or by a charging member 1716 for forming a charged flow generally indicated by the arrow 1718.

Charged flow 1718 is then passed out an outlet 1730 for forming a charged cloud generally indicated by the numeral 1732 comprised of a plurality of condensing charged particles generally indicated by the numeral 1734.

Condensing charged particles 1734 condense onto or otherwise combine with a plurality of harmful airborne agents generally indicated by the numeral 1740 for forming charged harmful airborne agents generally indicated by the numeral 1742 that are of a size for being electrostatically manipulatable.

Charged harmful airborne agents 1742 are then electrostatically manipulated for protecting an exposed surface 1750 from harmful airborne agents 1740.

Exposed surface 1750 can have a multilayered electret material 1760 adhesively attached thereto. Electret material 1760 is comprised of a number of similarly charged sheets 1762, 1764 and 1766 that are held together by an art adhesive not shown. As top layer 1762 of electret material 1760 become dirty or damaged it is peeled off for exposing a fresh clean electrostatically repelling surface.

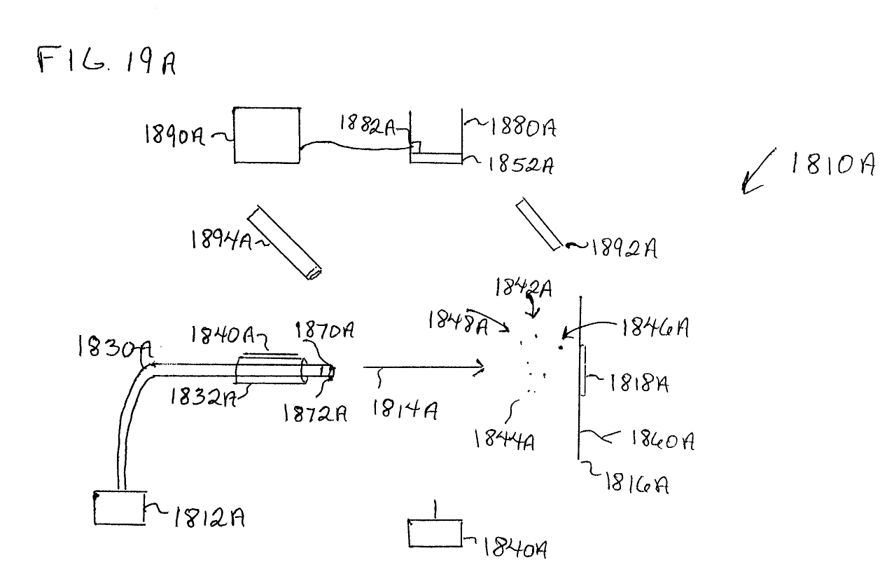

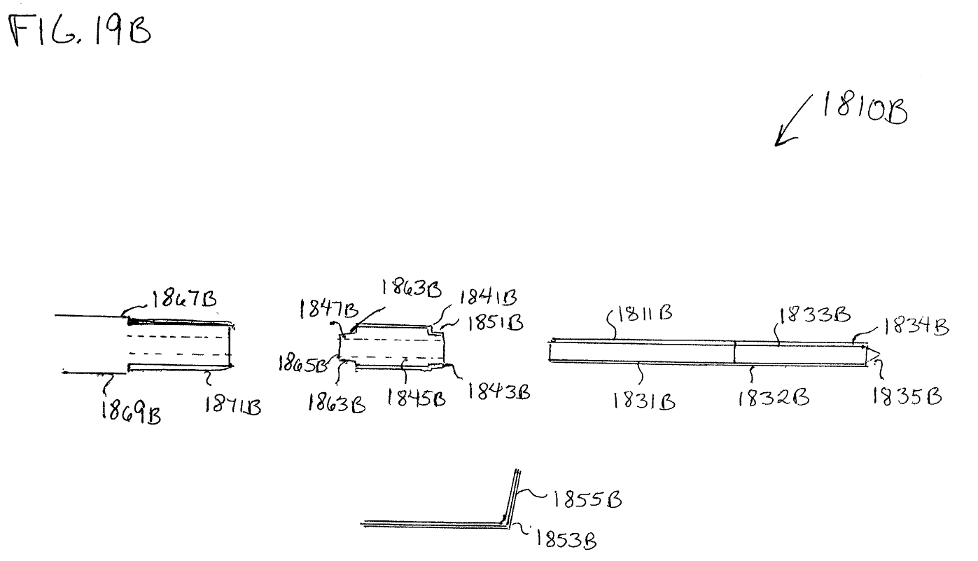

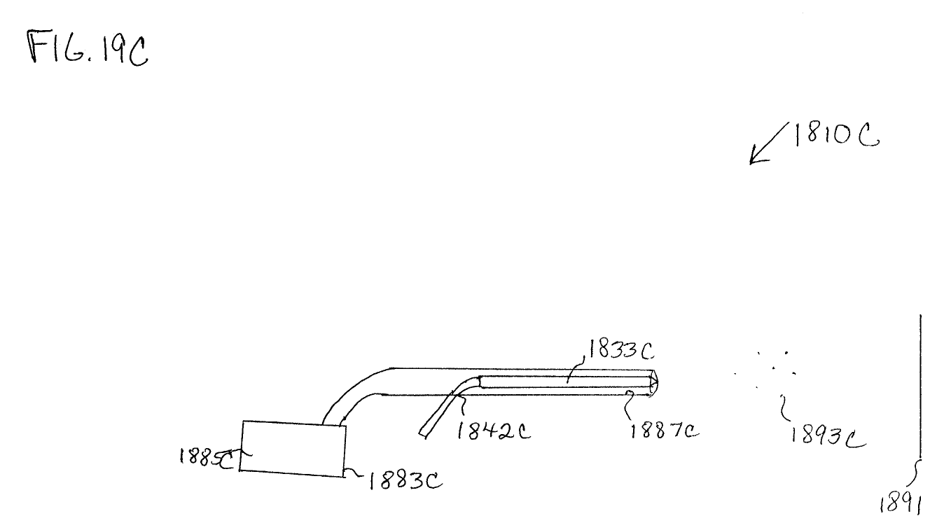

Now referring to FIG. 19A, there is shown a schematic of a method and apparatus for increasing the performance of a radiation source during therapeutic procedures. The apparatus is an electrostatically enhanced laser generally indicated by the numeral 1810A. The electrostatically enhanced laser is useful in the removal of bio-aerosol plumes created by a laser for (1) maintaining a high quality laser beam, (2) maintaining an adequate visual field, (3) for the protection of transmissive surfaces, and (4) for cooling the heated surgical site.

The electrostatically enhanced laser 1810A can operate as follows. First, an art radiation source 1812A delivers a predetermined amount of radiation in the form of a beam generally indicated by the arrow 1814A to a surgical site generally indicated by the numeral 1816A for removing an amount of tissue 1818A therefrom in the form of a plume generally indicated by the numeral 1820A and thereby heating site 1816A. Radiation source 1812A can be comprised of an art laser or lamp source.

Beam 1814A can be delivered through a fiber optic cable 1830A. Fiber optic cable 1830A can have a hand piece 1832A attached thereto at the distal end of cable 1830A for ease of handling.

In one form of the invention, after or during the actuation of radiation source 1812A, a charged particle source 1840A is directed at plume 1820A for forming a space charged cloud generally indicated by the numeral 1842A comprised of a plurality of charged particles generally indicated by the numeral 1844A therein. Charged particles 1844A combine with a plurality of harmful airborne agents generally indicated by the numeral 1846A comprising plume 1820A for forming a space charged plume generally indicated by the numeral 1848A.

Charged plume 1848A is then electrostatically dispelled. In one form of the invention, plume 1848A is dispelled due to the expanding space charge effect for maintaining an essentially transparent field in the path of beam 1814A.

In another form of the invention, exposed surface 1816A and or one or more electrodes 1852A can be charged in accordance with the teachings of the present invention for maintaining exposed surfaces 1816A free of harmful airborne agents 1846A.

In another form of the invention, surgical site 1816A and therefore the patient can be grounded by a cable 1860A for capturing charged plume 1848A. In this form of the invention, capturing of charged plume 1848A by site 1816A further cools site 1816A by an ionic wind effect.

In one form of the invention, charged particle source 1840A is positioned on hand piece 1832A for creating space charged cloud 1842A in front of an end portion 1870A of fiber optic cable 1830A for maintaining portion 1870A free of harmful airborne agents 1846A. End portion 1870A can be in the form of a window or lens 1872.

In another form of the invention, charged particle source 1840 is independently position able with respect to bio-aerosol generator or laser 1832A. In this form of the invention, charged particle source 1840A can be located and positioned for projecting charged particles 1844A in an at least partially tangential direction to beam 1814A for directing charged plume 1848A away form surgical site 1816A. In this form of the invention, charged member or electrode 1852A can be positioned a known distance from site 1816A for receiving charged plume 1848A. Charged member 1852A can be a mouth portion of an evacuation source 1880A and may be given an attractive ground potential. A current sensor 1882A can be electrically attached to charged member 1880A for:

a. determining the amount of material and kind of material removed from site 1816 by measuring both the current over time and the total amount of current received;

b. for determining the efficiency of collection of harmful airborne agents 1846A.

An electrical signal from sensor 1882 can be sent to an analyzer/display device 1890A for analyzing and display the electrical signal. Analyzer 1890A can be electrically connected to source 1812A for supplying feedback information for controlling the rate of removal of material from site 1816A. In this form of the invention, it is preferred to form the charged cloud 1842A be established before the irradiation of site 1816A for forming a well defined space charged cloud thereat.

In addition, electrode 1880A can be given an oscillating voltage, in a manner known in the art, for oscillating charged plume 1848A for forming acoustic waves therefrom. The acoustic waves are then received by a one or more acoustic detection devices 1892A for profiling charged plume 1848A for determining the amount and kind of material ejected from site 1816.

In still another form of the invention, a radiation source 1894A can be positioned and actuated for creating a photoacoustic signal from either the charged or uncharged plume. The photoacoustic signal can be received by devices 1892A.

Devices 1892A can also be electrically connected to analyzer/display device 1890A for analyzing and displaying the signal for providing feedback control to the operator or directly to source 1812A.

Now referring to FIG. 19B, there is shown a schematic of a charged particle source that is attached to a bio-aerosol source such as a laser. The charged particle source is a corona electrode generally indicated by the numeral 1810B.

Corona electrode 1810B is comprised of an electrode 1831B in the form of a thin long needle 1833B approximately 0.075 inches in diameter with a tip 1835B on a distal end portion 1837B thereof. Needle 1833B can be comprised of a refractory metal such as titanium or tungsten to provide extended efficient use and prevent “sputtering” i.e., rapid erosion, of needle material. Optimum taper for tip 1835B depends on the material utilized in its construction. If tungsten is utilized, tip 1835B has a machined angle of 18 degree tapering back from a tip hemispherical diameter of 0.0009. A titanium needle may be optimized with tip 1835B having a 60 degree taper. A shank portion 1832B of needle 1833B is surrounded by an electrical insulation layer 1834B which leaves only a tapered tip 1835B of approximately 0.25 inches long exposed for forming an intense non-uniform electric field thereat. Insulation layer 1835B is approximately 0.5 inches in length and extends down from tip 1835B to an outside screw thread 1839B portion of needle 1833B. Insulation layer 1834B can be comprised of glass, plastic and the like. In the preferred form of the invention, insulation layer 1834B is comprised of glass or other easily autoclavable material.

Needle 1833B has a screw thread 1811B for screwing into a distal end 1843B of a brass sleeve 1841. Sleeve 1841B is provided with a continuous bore 1845B having an inside screw thread 1847B. Sleeve 1841B is covered with a layer of insulation material 1849B along the main body portion thereof.

Distal end portion 1851B of brass sleeve 1841B is provided with an outside thread 1851B for insertion into an attachment member 1853B having a hole 1855B having a corresponding inside thread 1857B. Attachment member 1853B is covered with an insulation material 1861B and is insulated from handle portion 1832B.

Brass sleeve 1841B is connected by a proximal end portion 1863B comprised of an open-jawed or ring spanner 1865B to a second sleeve 1867B. Sleeve 1867B is provided with a continuous bore having an inside screw thread which matches outside screw thread 1839B of needle 1833B. Sleeve 1867B is covered with one or more insulation materials 1869B and 1871B that extend down to a handle portion 1873B.

Sleeve 1867B is electrically connected to a high voltage source through a cable through at least one high ohmic current limiting resistor.

In another form of the invention, corona electrode further comprises a gas flow protection tube for supplying an inert surgical grade gas, from a cylinder such as argon, helium or nitrogen to the discharge portion of needle for preventing the formation of toxic gases thereat and for reducing the puncture hazard of the needle. Or gas can be comprised of surgical grade oxygen for forming ozone at the discharge portion of needle. In this form of the invention, an ozone decomposition gas is supplied to or around the surgical site for reacting with the zone for forming a biocidal aerosol thereat.

Now referring to FIG. 19C, there is shown a schematic of a corona electrode having a gas flow protection tube therewith for protecting the user from toxic gases and punctures. The device is a protected corona electrode generally indicated by the numeral 1810C. Protected corona electrode 1810C can be bioaerosol generator mounted or be of a free standing type.

Protected corona electrode 1810C can comprises a gas flow tube 1842C. Tube 1842C is made of an insulting material such as but not limited to Pyrex glass. Tube 1842C is mounted co-axially with corona electrode 1833C and has a nearly flush end with the needle thereof for reducing the puncture hazard of device 1810C. Tube 1842C is fluidly connected to a source 1883C of an inert gas 1885C for forming a protecting inert layer of gas generally indicated by the numeral 1887C around tip portion 1835C for preventing the formation of ozone thereat. Source 1883C can be a source of cool gas for either (1) cooling an area generally indicated by the numeral 1891C, which can be a surgical site, that is within the vision field of tip 1835C or (2) for forming electrifying particles in the form of charged droplets of water condensed from an atmosphere surrounding needle 1833C and being generally indicated by the numeral 1893C.

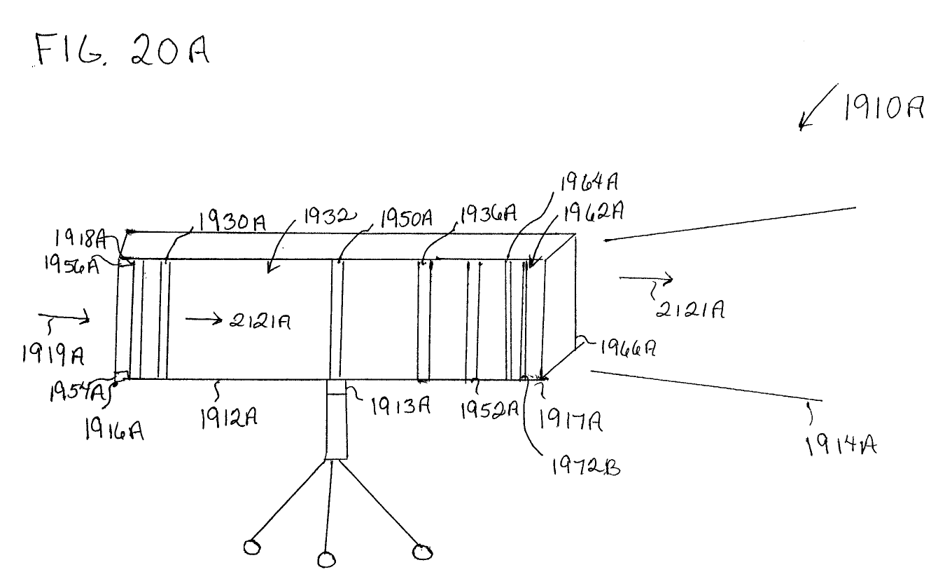

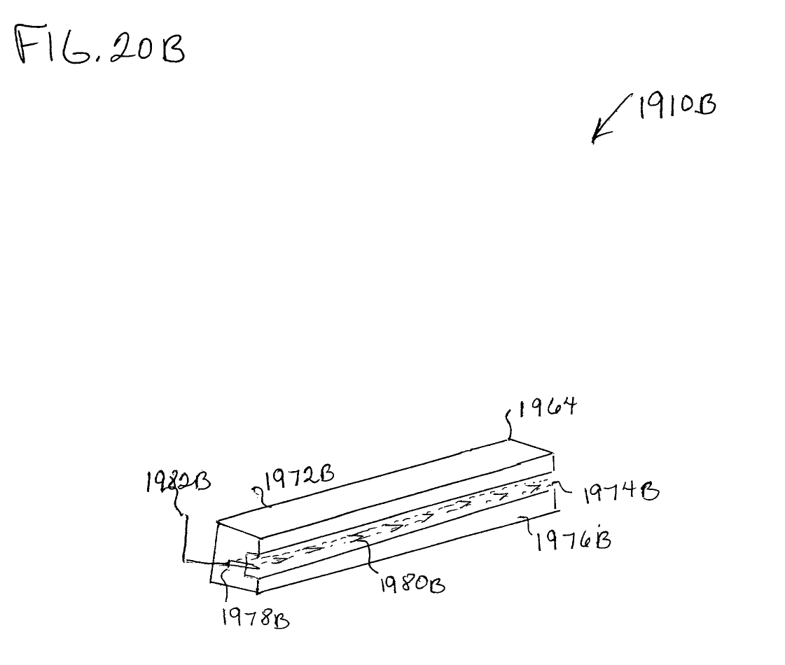

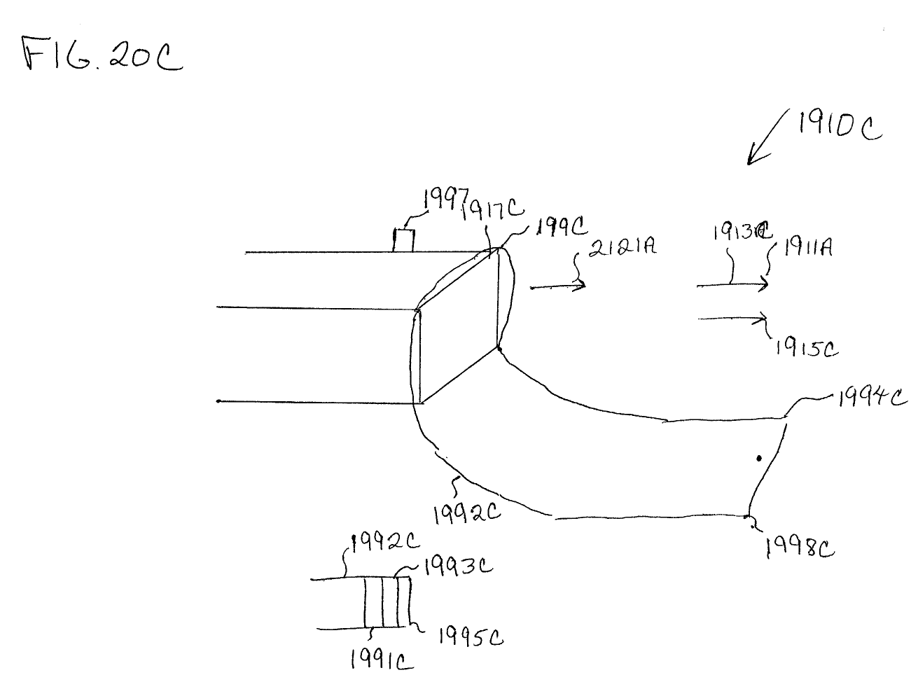

Now referring to FIG. 20A, there is shown a schematic of an apparatus for providing an electrostatically purified isolation flow. The apparatus is a portable electrostatically enhanced air curtain generally indicated by the numeral 1910A.

Enhanced air curtain 1910A comprises a doorway passable, rollably postionable housing 1912A. Housing 1912A is mounted on a position support 1913A for positioning of device 1910A at different heights and at different angles therewith for forming a clean fluid flowing zone generally indicated by the numeral 1914A where desired. Housing 1912A can be comprised of a metallic sheet material or can be made of a polymeric composition. For greater clarity that side face of housing 1912A which faces the viewer is illustrated as being transparent merely in figure.

Housing 1912A has an inlet portion 1916A for receiving air surrounding device 1910A and a discharge portion 1917A.

Housing 1912A is comprised of an gas sterilizer 1920A for passing a flow of a gas generally indicated by the arrow 1919A such as air through inlet portion 1916A for forming a laminar flow of clean or sterilized gas generally indicated by the arrow 2121A. Gas sterilizer 1920A can be of a type will known in the art, of one in accordance with the teachings of the present invention. In one form of the invention, sterilizer 1920A is comprised of: a pre-filter 1918A can be positioned at inlet 1916A for removing heavy particles; and a high efficiency particulate air filter or sterilization filter 1930A. Filter 1930A can be mounted transversely inside housing 1912A between a chamber portion 1932A and a discharge portion 1917A.

An interior electrically powered variable speed air moving assembly or blower 1936A can be placed in chamber 1932A for providing a flow that passes through both filters 1918A and 1930A and out discharge end 1934A for forming flow 2121A at a velocity of between, for example, 350 to 800 fpm or thereabouts.

A humidifier 1950A and heater 1952A can be provided in conjunction with a humidity detector 1954A and temperature sensor 1956A for controlling the temperature and level of moisture of flow 2121A. Humidifier 1950A may be any commercially available units such as Nebutherm I nebulizer heater manufactured by Automatric Liquid Packagings, Health Care Products Division.

Discharge portion 1917A is comprised of an empty space generally indicated by the numeral 1962A where gas phase ionization or charging of particles can take place. At least one charged particle source 1964A is provided on or in at least one wall 1966A of discharge portion 1917A for forming an ionic channel that is in fluid communication with space 1962A for passing electrifying particles thereto.

In one form of the invention, charged particle source 1964A is an art type that provides for a charged particle cloud that is comprised of a plurality of unipolar charged particles. Charged particle source 1964A can be of a type well known in the art for producing a charged cloud of unipolar particles including, but not limited to, corona or discharge sources, radioactive emitters, ionizers and spray devices or can be of a type described in the present invention. It will of course be understood by those in the art that other techniques and apparatus to accomplish the ionization of gas flows for other purposes may be utilized here as well. A preferred ionization technique and apparatus will be described subsequently.

In one form of the invention, charged particle source 1964A is comprised of one or more corona elements 1970A for forming electrifying particles by discharge processes. In this form of the invention and in those where ozone gas is produced, a source of volatile ozone decomposition material 1972A can be provided for decomposing ozone. In the preferred form of the invention, source 1972A is a source of decomposition material for decomposing ozone for forming a gaseous biocide. In particular, source 1972 can be a source of iodine or an organic compound that forms an oxidizing agent such as but not limited to an organic peroxide or acid. In the preferred form of the invention, the organic compound is comprised of a terpene compound. Source 1972A may be comprised of a heater 1974A for vaporizing the ozone decomposition material.

Other preferred sources of charged particles suitable for use with the present invention, include ¹³⁷CE and ⁶⁰Co both of which not supply charged particles but also provide for a sterilizing action. Other radioactive sources of charged particles may be alpha rays, a beta ray, and a gamma ray.

As seen in FIG. 20B, corona element 1964 can be comprised of a removable and/or disposable elongate bar 1972B having an indentation or notch 1974B along the length of one side 1976B thereof and is similar in construction to the bar electrode as described in U.S. Pat. No. 4,477,263. Bar 1972B is composed of an insulating material such as a polymeric composition. A conductive member 1978B is embedded into bar 1972B for supplying one or more conductive spikes or needles 1980B with high voltage. Needles 1980B extend from member 1978B through the middle of indentation 1974B so as to be about flush or flush with side 1976B.

Member 1978B is connected to an active pole 1982B of a source 1984B of high voltage, such as direct current for providing needles 1980B with 15,000 to 35,000 volts of energy through a surge protected cable. Instead of the source of direct current voltage, it is also possible to use a source of high voltage alternating current for the agglomeration and charging of particles within the flow.

In one form of the invention, an external electrode, which may be in the form of a drape 1992C as shown in FIG. 20C can provided for stratifying charged flow 2121A for forming a stratified curtain generally indicated by the numeral 1911C comprising a harmful airborne agent laden layer 1913C and a less laden layer 1915C. Drape 1992C is comprised of a plurality of layers 1991C, 1993C, and 1995C having differing conductivities for forming a low surge surface therewith. Drape 1992C has an elastically lined cut-out portion 1996C through which discharge portion 1917 extends. Drape 1992C further comprises a floor portion 1998C that can extend from a measured distance starting at the end of discharge portion 1917 to about 5 to 10 feet out. Floor portion 1998C can have an adhesive backing for sticking floor portion 1998C to the floor. Drape 1992C is provided with high voltage direct current through a surge protected cable 1994C.

In another form of the invention, drape 1992C is comprised of an electret material.

An aiming light 1997A can be provided on top of housing 1912A and positioned so that a beam of light from light generally indicated by the arrow 1999A intersects a clean air zone 1914A to the desired usable extent.

In another form of the invention, the charged particle cloud is comprised of a plurality of mixed charges. For this purpose, charged particle source 1964A can be a UV ionizer, an x-ray ionizer or a radioactive source.

While the flow through the enhanced air curtain 1910A is shown as passing from through inlet 1916A through sterilizer 1920A, the humidifier 1950A, the blower 1936A, heater 1952A and charger 1964A to exit through discharge port 1917A, the components may of course be arrange by those of ordinary skill in the art in any order as desired for forming an environmentally controlled and charged flow of air.

The operation of the electrostatically enhanced air curtain in conjunction with an airborne agent deflector for the protection of exposed surfaces on patients and/or medical staff members during a medical procedure is given as one non-limiting example of the many embodiments provided by the present invention.

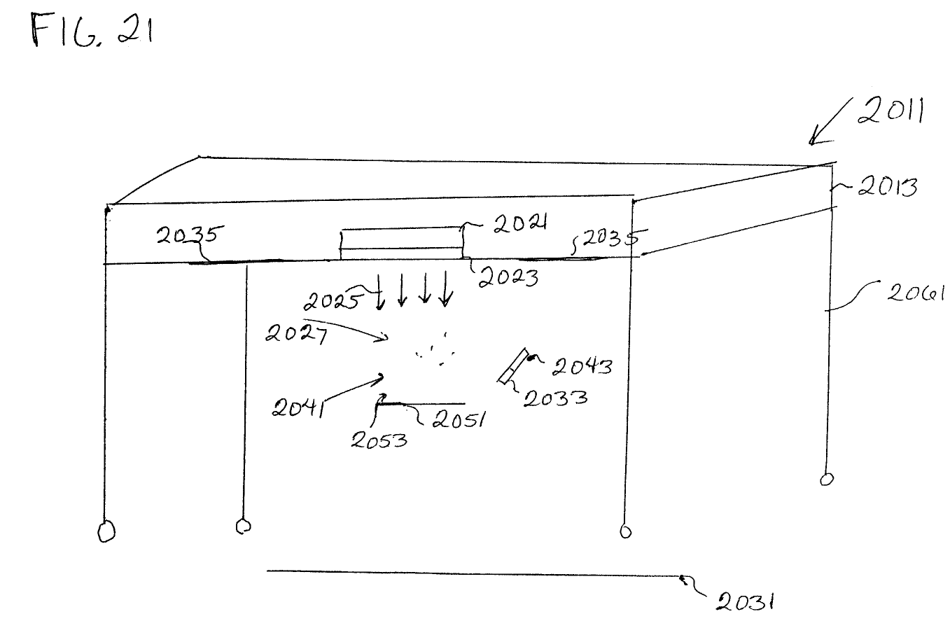

Now referring to FIG. 21 there is shown a schematic of a method and apparatus for protecting one or more exposed surfaces during a medical procedure utilizing an electrostatically enhanced air curtain and a deflecting electrode. The apparatus is a total flow control device generally indicated by the numeral 2011.

The operation of the flow control device 2011 is as follows, first an enhanced air curtain device 2013 is provided over an area generally indicated by the numeral 2015 wherein a medical procedure, such as but not limited to an evasive medical procedure is to take place. Enhanced air curtain 2013 can be provided as part of a ceiling structure or can be provided over area 2015 by use of a rollable and height adjustable enhanced air curtain 2017 as shown.

After the enhanced air curtain 2013 has been positioned, a blower 2021 and one or more charged particle sources 2023 are actuated for providing a sterile humidified electrifying laminar flow generally indicated by the arrow 2025 of singly charged particles generally indicated by the numeral 2027 in the form an expanding spaced charged electrohydrodynamic flow having an essentially uniform velocity throughout.

One or more directing electrodes 2031, 2033 and 2035 are then actuated for influencing the flow pattern of flow 2025.

With the formation of flow 2025 and the actuation of the directing electrodes the medical procedure is then began. As the procedure proceeds a plurality of harmful airborne agents that can be (1) contained in flow 2025, (2) brought into charged flow 2025 by induction effects, or (3) are subsequently created in charged flow 2025 by the procedure are electrified for forming a plurality of charged harmful airborne agents generally indicated by the numeral 2041 therein. Harmful airborne agents 2041 can be, and in no way limiting the present invention to any particular harmful airborne agent, of a type produced during a medical procedure such as, but not limited to one or more of the following: emitted particles from patients or hospital staff such as respiratory droplets expelled from the mouth during breathing, coughing, sneezing or speaking; (2) skin squamae emitted during the movement of a human body; and (3) potential disease-carrying aerosols produced from blood and other bodily fluids, small particles of skin, fat, muscle tissue and bone created during the manipulation of one or more medical tools. In the present exemplary illustration, a medical tool 2043 in the form of an electric saw having an electrode in the form of an attractive shield 2045.

In one form of the invention, an exposed surface 2051 is actuated for forming a comparatively non-flowing non-depositional micro-environment generally indicated by the numeral 2053 adjacent or proximal to exposed surface 2051. In the exemplary illustration, and in no way limiting the present invention to any particular type of exposed surface, exposed surfaces 2053 can be in the form of the eyes, or open wounds, and the like of one or more persons such as a patient and/or medical staff member or can be a surface of inanimate object 2051 such as a medical contact surface as shown.

In those cases wherein the exposed surface is in the form of a wound, the micro-environment in addition to stopping the spread of airborne diseases also functions to minimize the disruption of the environment immediately surrounding the wound by the charged flow for minimizing convective and evaporative heat losses. This allows for flow 2025 to be of a lower temperature than ordinarily used for surgical purposes.

In another form of the invention, a plurality of transparent electrode wall panels 2061 are provided for controlling the electrohydrodynamic flow 2025 and/or colleting charged harmful airborne agents.

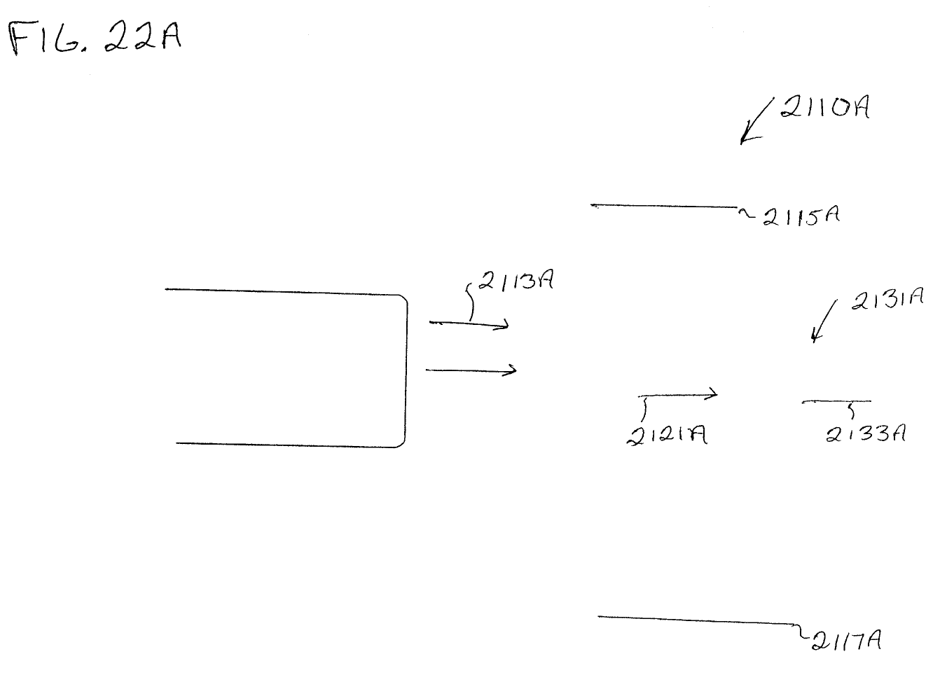

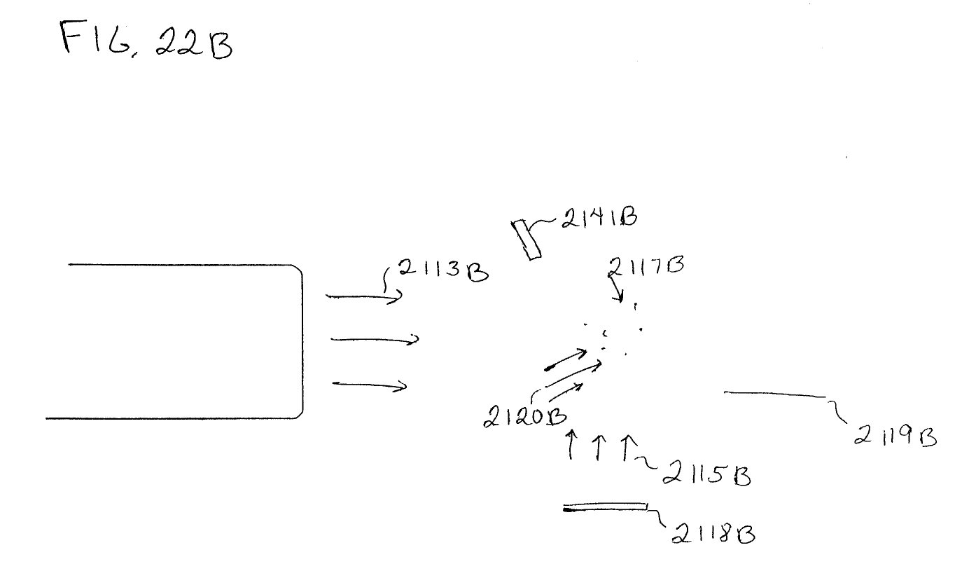

Now referring to FIG. 22A, there is shown a schematic of a method useful in the operation of a stratified flow for protecting one or more exposed surfaces.

Electrostatically enhanced air curtain 2110A can operate in a stratified mode as follows. After a charged flow generally indicated by the arrow 2113A of single polarity has been established, one or more electrodes such as a ceiling mounted electrode 2115A, and/or a floor 2117A are then activated for forming an electrostatic field having at least one vector component transverse to flow 2113A for forming at least one air flow zone generally indicated by the numeral 2121A in flow 2113A having a lower particle count therein.

Air flow zone 2121A is then directed at an area 2131A containing one or more exposed surfaces 2133A for maintaining a low particle count thereat.

In another form of the invention, electrostatically enhanced air curtain can be operated as shown in FIG. 22B.

As shown in FIG. 22B, after flow generally indicated by the arrow 2113B of single charge has been established, a directing electrostatic field generally indicated by the arrows 2115B created by an electrode 2118B is placed in the flow path of flow 2113B for both (1) directing a plurality of charged agents 2117B away from an exposed surface 2119B and for (2) for imparting flow 2113B with a velocity component generally indicated by the arrows 2120 for directing uncharged harmful airborne agents, that may for example be created by a bio-aerosol generator 2141B, away from exposed surface 2119B. In this form of the invention, both charged and uncharged airborne agents that would due to their momentum otherwise come into contact with exposed surface 2119B are directed away for maintaining exposed surface 2119B substantially free of deposited harmful airborne agents. Directing electrostatic field 2115B can be created by one or more electrodes as illustrated by numeral 2118B which can be of a type well known in the art or one in accordance with the teaching of the present invention.

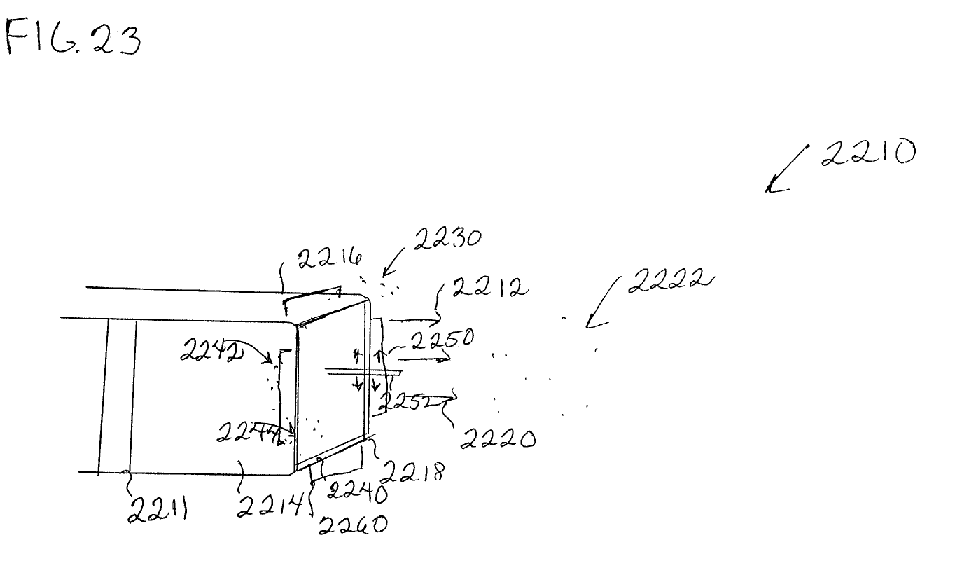

Now referring to FIG. 23 there is shown a method and apparatus for forming an induction protected full air curtain. The apparatus is an induction protected air curtain generally indicated by the numeral 2210.

The electrostatically protected air curtain 2210 operates as now described. First, a blower 2211, which can be a fan, compressor or other known device for moving air, is activated for forming a flow generally indicated by the arrow 2212 of a gas 2214 through a conduit 2216 and out an outlet 2218 for forming an “air curtain” or flow generally indicated by the arrow 2220 in a sea of harmful airborne agents generally indicated by the numeral 2222. Outlet 2218 can be in the form of an open air way as shown or be in the form of a diffuser, register or grille. In one form of the invention, outlet 2218 is comprised of a non-conductive material such as plastic.

The formation of curtain 2220 creates a well known region of low pressure region generally indicated by the numeral 2230, which is often called the induction or entrainment or aspiration zone at outlet 2218.

With the passage of the flow 2220 through outlet 2218, a charged particle source 2240 in the form of one or more electrode bars is actuated for forming a cloud of charged particles generally indicated by the numeral 2242. Cloud 2242 is then directed through at least a portion of low pressure region 2230 for:

a. electrifying harmful airborne agents therein for forming a plurality of charged harmful airborne agents generally indicated by the numeral 2244; and

b. for electrostatically manipulating charged harmful airborne agents 2244 away from flow 2220 for the protection of the same.

In one form of the invention, an electrostatic field generally indicated by the arrows 2250 is formed by a repulsion electrodes 2252 centered in conduit 2216 for repelling charged harmful airborne agents 2244 are away from flow 2220.

In another form of the invention, repulsion electrodes 2252 are in the form of a corona electrode that is utilized for both (1) producing the charged cloud 2242 and for (2) repelling the charged harmful airborne agents 2244 away from flow 2220.

In another form of the invention, an electrostatic field is formed by a combination of repulsion electrodes 2252 and one or more attraction electrodes 2260 for both repelling and attracting charged harmful airborne agents 2244 away from flow 2220.

In one form of the invention, attraction electrodes 2260 are in the form of grounded electrodes. In this form of the invention, attraction electrodes 2260 can be grounded by an electrically conductive cable 2270 that is attached to ground.

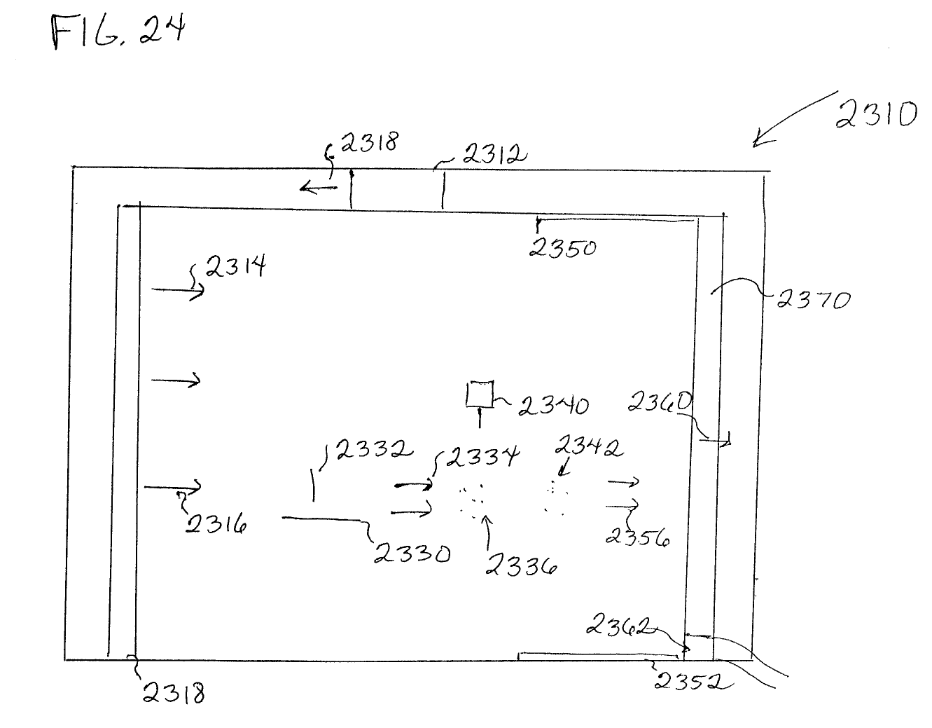

Now referring to FIG. 24, there is shown a method and apparatus for forming a purified air in an enclosed area using recycled air. The apparatus is harmful airborne agents stratisfier/separator generally indicated by the numeral 2310.

The stratisfier/separator 2310 operates in a manner now described. First, a blower 2312 is actuated for forming a flow of a gas 2314, such as air, generally indicated by the arrow 2316. Gas 2314 can be in the form of ultra-high purity gas created, by for example, passing a flow generally indicated by the arrow 2318 through a bank of HEPA filters 2320 or other art purification devices.

Flow 2316 can then be passed over one or more exposed surfaces 2330 that are being manipulated upon by an aerosol generator 2332 for maintaining a low particle count on exposed surfaces 2330 and for forming a flow generally indicated by the arrow 2334 of used air containing a plurality of harmful airborne agents 2336 that have been collected by flow 2314 as it traveled past aerosol generator 2332.

The harmful airborne agents 2336 in used flow 2334 are then electrified by a charged particle source 2340 for forming a plurality of charged harmful airborne agents 2342 within the enclosed area.

The charged harmful airborne agents 2342 are then stratified in used flow 2334 by the use of one or more electrodes such as a ceiling electrode 2350 and floor electrode 2352 for forming a stratified flow of used air generally indicated by the arrow 2356. In the preferred form of the invention electrodes 2350 and 2352 are positioned and charged for stratifying charged harmful airborne agents 2342 on the bottom of flow 2356.

The layers of stratified flow 2356 are then separated for forming a substantially pure flow generally indicated by the arrow 2360 and a comparatively dirty flow generally indicated by the arrow 2362. Pure flow 2360 is then passed through a second bank of HEPA filters 2370 and recycled into flow 2318.

In another form of the invention, an electrostatic charge is placed on a surface of filter banks 2370 for maintaining charged harmful airborne agents out of flow 2318.

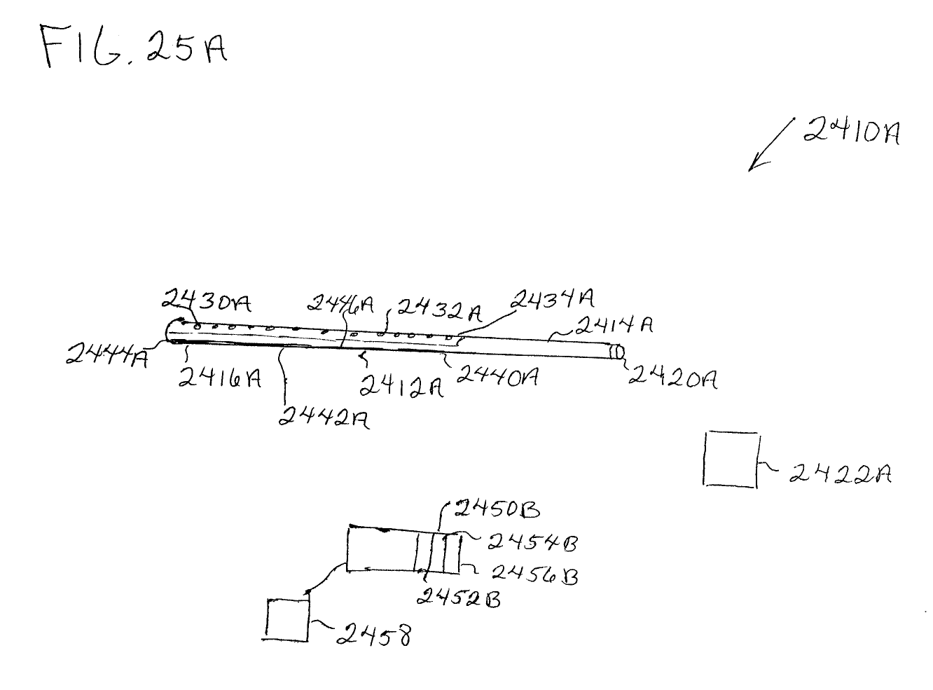

Now referring to FIG. 25A there is shown a schematic of a method and apparatus for the collection of harmful airborne agents by a conformable porous electrode in the form of an electrified hose. The apparatus is an electric hose evacuator generally indicated by the numeral 2410A.

The hose evacuator 2410A is comprised of a hose 2412A having a proximal portion 2414A and a distal portion 2416A. Hose 2412A can be comprised of a flexible nonconductive plastic material such as, but not limited to, polyethylene, polypropylene, nylon or polytetrafluoroethylene for forming a structure conformable to different types and sizes of surgical areas for electrostatically enhancing the evacuation of bioaerosols generated or brought thereto.

Proximal portion 2414A is comprised fo a fastener member 2420A for detachably fastening hose 2412A to an art vacuum or suction source 2422A for applying controlled suction thereto. Such vacuum mechanisms are well known and will, therefore, not be described in detail.

Distal portion 2416A is comprised of a plurality of inlet apertures 2430A along one side 2432A thereof. Side 2432A is comprised of a charging member 2434A. In one form of the invention, charging member 2434A is in the form of an electret for attracting charged particles thereto.

Distal portion 2416A further comprises an opposite side 2440A having an adhesive strip 2442A attached thereto for affixing distal portion 2416A to a surgical site in a conformational manner. Adhesive strip 2442A can be directly attached to distal portion 2416A or can be attached to a resilient form like layer 2444A placed therebetween as shown for allowing for better conformation. Adhesive strip 2442A is covered prior to use with either a paper or plastic cover 2446A.

In another form of the invention, and as shown in FIG. 25B, side 2432 is provided with a voltage driven electrode 2450B comprised of a number of laminated sheets 2452B, 2454B, and 2456B having differing conductivities for forming a low surge electrode that is connected to a high voltage source 2458.

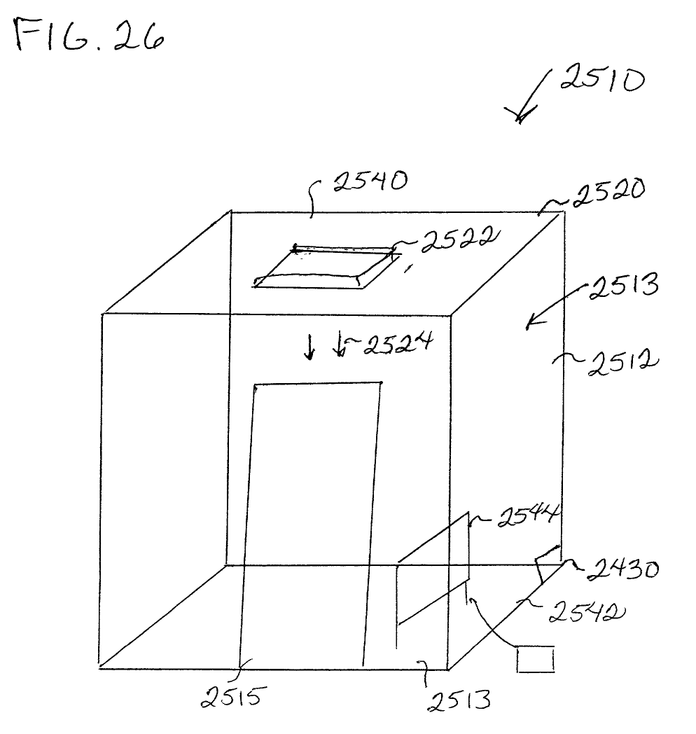

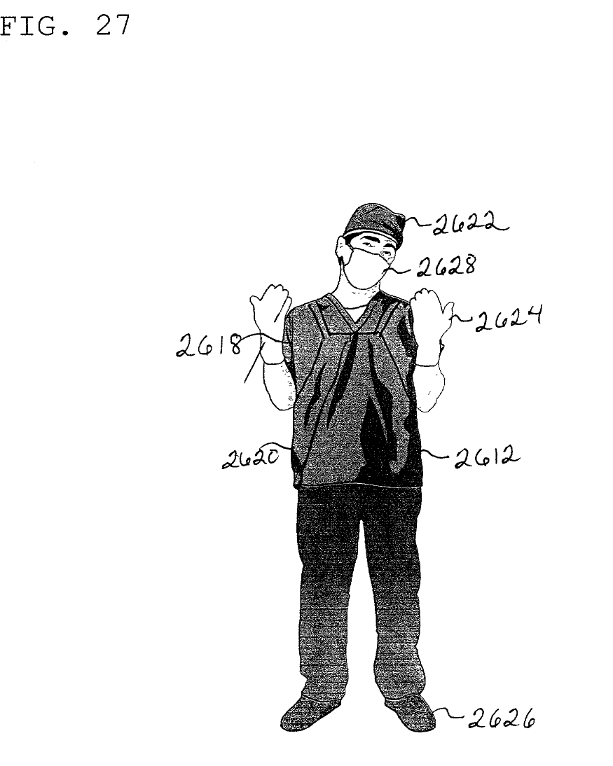

Now referring to FIG. 26 there is shown a schematic of a method and apparatus of an electrostatically enhanced isolation booth. The booth is a self-contained portable isolation and environmental protection life support system for either protecting a transmissive surface therein on for example a patient contained therein. The apparatus is an portable electrostatically enhanced booth generally indicated by the numeral 2510.

Electrostatically enhanced booth 2510 is of a size for assemble within the confines of a hospital room and is comprised of at least one walling section(s) 2512 for walling off an enclosed section generally indicated by the numeral 2513 of booth 2510 to the outside. In one form of the invention, walling section(s) 2512 is comprised of four vertical sections, which may be of equal width as shown. Walling section(s) 2512 can be essentially transparent in nature and be in the form of a wall electrode as described herein. A wall section 2513 may be provided with an access means such as a door or curtain 2515 of art type for entry of a person or stretcher.

Booth 2510 further comprises a roof section 2520 which can be seallingly attached to said wall section(s) 2512 for providing for an air tight fitting. Roof section 2520 is provided with a charger/blower 2522 for supplying a flow generally indicated by the arrow 2524 of electrostatically charged breathable gas such as clean or purified or sterile air into booth 2510 for forming an electrified atmosphere or electrohydrodynamic flow therein. Charger/blower 2522 can be in the form of an electrostatically enhanced air flow or curtain as described herein. In the preferred form of the invention, charger/blower 2522 provides for flow 2524 having both a laminar nature and of essentially uniform velocity throughout.

Booth 2510 still further comprises an air outlet section 2430 for removing air from booth 2510.

Booth 2510 can further comprise a plurality of low surge electrodes 2538 such as a ceiling electrode 2540 in the form of a ceiling, floor electrode 2542 that makes substantially the entire floor area and an additional electrode 2544. Electrodes 2538 can be in the form of electrets or be voltage driven.

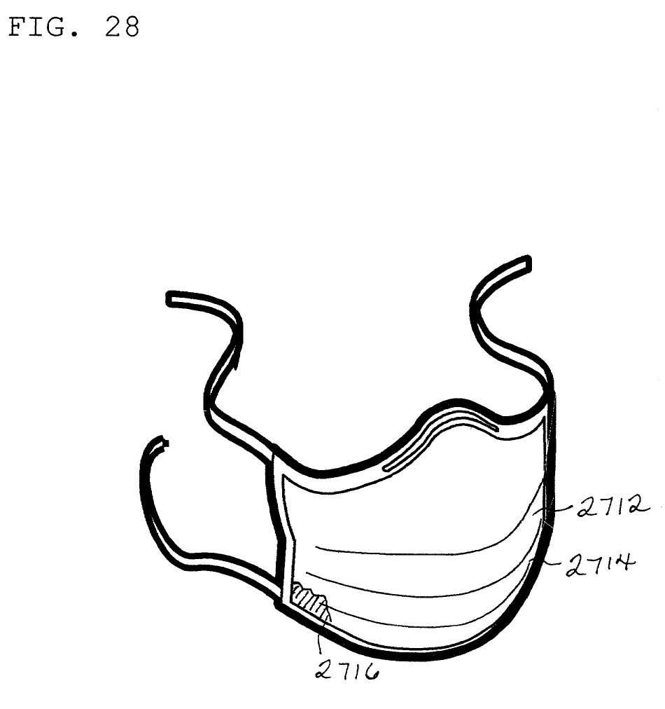

Now referring to FIG. 27 there is shown a schematic of a method and apparatus for an electrostatically enhanced protective article of clothing. The apparatus is an electrostatically enhanced article of clothing generally indicated by the numeral 2610.

The article of clothing 2610 comprises at least one sheet of flexible electret material 2612 having a singly charged electret portion thereon, which may be woven or solid in nature for forming an electrostatic field perpendicular to its surface. In the preferred form of the invention, material 2612 forms an outer layer 2614 of article of clothing 2610.

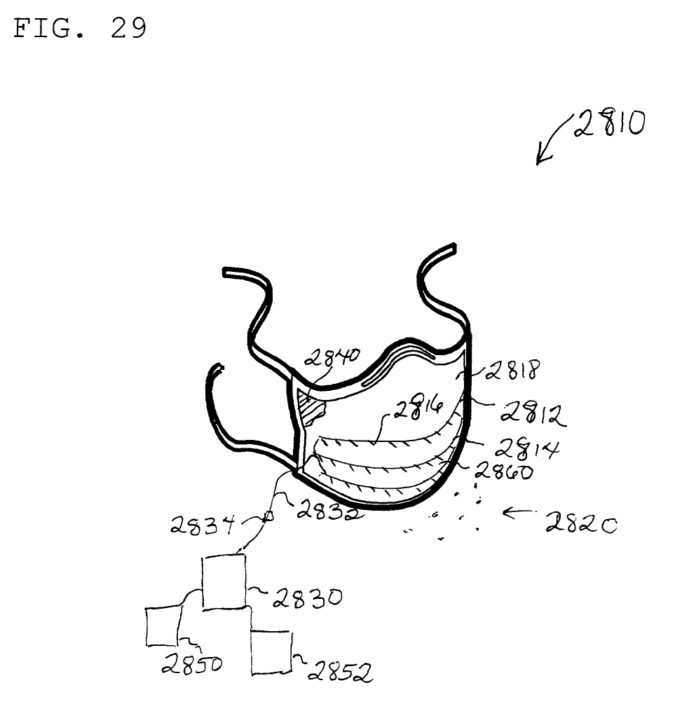

Article of clothing 2610 can be in the form of surgical garments such as, but not limited to, a gown 2618, a cap 2622, an apron 2620, a plurality of surgical gloves 2624, a plurality of shoe coverings 2626 and a mask 2628. Now referring to FIG. 28 there is shown a schematic an article of clothing in the form of a mask 2710.

Mask 2710 is comprised of an electret layer 2712 preferrable located on an outside portion 2714 thereof and an inner layer 2716 of ozone removing material. Ozone material 2716 can be in the form of a catalytic layer such as silver gauze or can be in the form of a layer of absorbent material such as paper or cotton impregnated with an ozone decomposition material such as a terpene compound. Terpene compound can be in the form of a fragrance, such as limonene or pinene for providing a pleasant smell to the wearer.

Now referring to FIG. 29 there is shown a schematic of a method and apparatus for filtering air by use of an electrostatic mask. The apparatus is an electrostatic repellant mask generally indicated by the numeral 2810.

Electrostatic mask 2810 comprises at least one charged particle source 2812, which can be in the form of a discharge source 2812 comprised of one or more bars, such as a corona discharge device. In the preferred from of the invention, one or more conductive member(s) 2814 comprised of a thin electrically conductive material are embedded into mask 2810.

A plurality of corona electrodes are attached to members 2814 and protrude through an outer layer 2818 mask 2810 for forming a uniform cloud of electrifying particles generally indicated by the numeral 2820 in front of mask 2810 when activated.

In one form of the invention, members 2814 are electrically connected to a source of high voltage 2830 through a cable 2832 having at least one current limiting resistor 2834 therein. High voltage source can be driven in any known manner. In the preferred form of the invention, source 2830 is supplied with power through either a battery 2850 or capacitor 2852 in a known manner. Source 2830 can be of a type for providing a plurality of singly charged particles using an AC or DC mode of operation. Source 2830 and power supply 2850 can be of an art type that fits into the front pocket shirt of the wearer.

Filter mask 2810 further comprises an ozone decomposition layer 2840 for decomposing any ozone generated during the operation of mask 2810.

In another form of the invention, mask 2810 is comprised of an outer electret layer 2860 for increasing the repulsion of charged particles 2820.

I claim:

1. An apparatus for protecting transmissive surfaces from infectious airborne agents, said apparatus comprising:
a. means for providing and directing a sterile flow of charged breathable gas in the form of an electrohydrodynamic flow over a transmissive surface; and
b. means for influencing the movement of said electrohydrodynamic flow for protecting said transmissive surface.
